(19) United States
(12) Patent Application Publication
(10) Pub. No.: US 2007/0011924 A1
(43) Pub. Date: Jan. 18, 2007

(54) Multi Image Display Device

(75) Inventor: Yossi Dana, Jerusalem (IL)

Correspondence Address: WOLF, BLOCK, SCHORR & SOLIS-COHEN LLP, 250 PARK AVENUE, NEW YORK, NY, 10177, US

(73) Assignee: IMM Technologies Ltd., Jerusalem (IL)

(21) Appl. No.: 11/533,988

(22) Filed: Sep. 21, 2006

Related U.S. Application Data
(63) Continuation-in-part of application No. PCT/IL05/00340, filed on Mar. 24, 2005.
Application No. PCT/IL05/00340 is a continuation-in-part of application No. 10/333,823, filed on Jan. 23, 2003.

(30) Foreign Application Priority Data
Mar. 25, 2004 (IL) 161097

(51) Int. Cl. G03B 25/02; G06K 7/00

(52) U.S. Cl. 40/454; 235/486

(57) ABSTRACT

A display device including an image selector, for selectively displaying images of a multi-image indicia carrier, a back board, a motor that provides relative movement between the back board and the image selector and an indicia carrier detachably placed between the image selector and the back board, such that it moves with the back board, at least partially due to a non-interlocking coupling of the indicia carrier to the back board.

### RELATED APPLICATIONS

The present application is a continuation in part (CIP) of PCT application PCT/IL2005/000340, filed Mar. 24, 2005, published as WO 2005/093696 and designating the United States, and of U.S. patent application Ser. No. 10/333,823, published as US patent publication US2004/0020088, the disclosure of which is incorporated herein by reference.

### FIELD OF THE INVENTION

The present invention relates to display devices and the calibration thereof

### BACKGROUND OF THE INVENTION

Display devices with changing images have been used for many years, some on small, handheld devices, others on desktop-sized displays, for example as toys and educational displays. Medium size varying image displays are used as indoor advertisements, and large displays are used for outdoor street signs. In one type of multi-picture displays, all the segments of all the pictures are arranged on a single indicia in a special spatial configuration. To display the images of a series of N pictures, each of the N pictures are segmented into M strips. The strips are deposited or otherwise created on an “indicia carrier” (e.g., a paper sheet). The composite of all the strips is the indicia. In the indicia all the strips are parallel to one another. The indicia carrier may be made of any appropriate material which is of stable dimensions.

The indicia is viewed through an array of parallel cylindrical lenses. The cylindrical lens array is so designed that the distance between the focal points (lines) of the component lenses is equal to the width of the lenses and each lens views one strip. The indicia is oriented so that the strip centers are parallel to the focal lines of the cylindrical lenses of the array.

A property of this configuration is that the segments have an equal width and the centers of the segments of one picture are offset by a fixed linear amount from centers of the segments of a second picture.

The image displayed is of that picture whose linear segments (strips) are centered along the focal lines of the cylindrical lenses, from the point of view of a viewer. In some cases, the indicia carrier is attached to the lens array and the images change by movement of the viewer. In other cases, the lens array or indicia are moved in order to change the images. By shifting the lens array (or indicia), in a direction perpendicular to the segments, by the fixed linear amount, a different picture is selectively displayed. This technique is described, for example, in U.S. Pat. No. 1,475,430, issued Nov. 27, 1923, and more recently in Japanese Patent HEI 2-211437 published Aug. 22, 1990. A recent method for the manufacture of an indicia has been described in U.S. Pat. No. 5,100,330 issued Mar. 31, 1992. The disclosures of all of the above patent publications are incorporated herein by reference.

The presentation using indicia carriers typically demands accuracy, particularly in the dimensional relationship of indicia parameters and the pitch of the array of lenses. While such accuracy is definitely achievable with small display units, the difficulty in achieving such accuracy may be the reason for lack of practical large lens displays.

EP patent publication 1 001 401, from May 17, 2000, the disclosure of which is incorporated herein by reference, describes a display device for multiple image indicia carriers having a cam and an oscillator to affect changes between images.

Japanese patent JP 02 211437, Aug. 22, 1990, the disclosure of which is incorporated herein by reference describes a display device for multiple image indicia carriers having a motor and controller that select images.

It is important in some of these displays that the indicia carrier be placed against the lens array evenly for correct optical display of the image. If a portion of the image retracts from the lens for some reason, the images will be distorted. The easiest solution is to glue the indicia carrier against the lens array. If, however, it is desired to replace the images and/or to move the images relative to the lens, this solution is not applicable. In one known display unit, the indicia carrier is attached to two parallel rods which move the indicia carrier relative to the lens array. The indicia carrier is attached with over ten pins, to ensure proper attachment adjacent the lens array. In addition, a sponge presses against the indicia carrier to ensure that it does not retract from the lens array. The indicia carrier is moved relative to the lens array and the sponge, while substantially being pressed between them.

### SUMMARY OF THE INVENTION

An aspect of some embodiments of the present invention relates to a multi-image display unit, in which an indicia carrier is pressed between an image selector and a back board, which move relative to each other (i.e., the back board and/or image selector move) in order to induce the change of the display. The indicia carrier is coupled to the back board with a temporary coupling which allows fast replacement of the indicia carrier, without replacing the back board. The use of a moving back board allows for achieving smooth pressing of the indicia carrier against the image selector, without using a complex coupling system, while having the indicia carrier move relative to the image selector. In some embodiments of the invention, the detachable coupling of the indicia carrier to the back board is mostly without any interlocking (e.g., pins, hooks, snaps), for example including interlocking on at most one side and/or including up to 2-5 interlocking units. Using interlocking coupling is time consuming at the time of installation and limits the coupling to a limited number of points, which may tear or distort.

In some embodiments of the invention, the back board and the indicia carrier are formed of materials that have a high relative friction, such that the indicia carrier moves with the back board due to the friction. Optionally, the relative friction between the indicia carrier and the image selector is relatively low, for example at least 5, 10 or even a hundred times lower than the friction between the indicia carrier and the back board, such that the image selector does not interfere with the movement of the indicia carrier. In some embodiments of the invention, the indicia carrier is not attached to the back board at all Alternatively, the indicia carrier is attached to the back board at several points (e.g., one or two points), in order to aid in the replacement of the indicia carrier, especially in large displays. In some embodiments of the invention, the attachment points are at a single face of the indicia carrier. Optionally, the attachment at the attachment points is not sufficient in order to move the indicia carrier with the back board, absent the high friction. For example, without the friction the indicia carrier may be distorted, bend or tear responsive to the movement of the backboard.

Alternatively or additionally to using friction, other methods are used to attach the indicia carrier to the back board in an easily detachable manner. In some embodiments of the invention, the indicia carrier includes weak glue spots that attach to the back board. The glue is weak enough to allow easy removal of the indicia carrier from the back board. Alternatively or additionally, the back board includes magnets and the indicia carrier includes iron dust or foil.

An aspect of some embodiments of the present invention relates to providing a multi-image display device with a cooling mechanism. Optionally, the cooling mechanism includes a fan which blows relatively cool air onto and/or through one or more of the elements of the multi-image display device. Alternatively or additionally, the cooling mechanism includes a heat pump, vents and/or flow channels.

An aspect of some embodiments of the present invention relates to providing a multi-image display device with a fan which circulates air within a housing of the display device. The circulated air optionally includes hot and/or cool air for affecting the temperature of one or more elements of the display device.

In some embodiments of the invention, the fan operates continuously, passing air through the housing regardless of the temperature in the housing. Alternatively, the fan is controlled by a thermostat, which begins the operation of the fan only when the temperature in the housing (e.g., near the indicia carrier) is in a predetermined range. Optionally, the fan is operated when the temperature in the housing exceeds a threshold temperature above 50° or even above 60°. Alternatively or additionally, the fan is operated when the temperature is below a predetermined threshold. Optionally, in accordance with this alternative, a heater is used to heat the air supplied by the fan, when the temperature within the housing is low.

Optionally, the air blown by the fan is filtered.

An aspect of some embodiments of the invention relates to an indicia carrier having a lens formed of a material durable against distortions which impede the viewed image due to heat up to at least 100° C., up to at least 110° C. or even up to at least 120° C. While the cost of a lens with durability up to such temperatures may be higher than the cost of other lenses, such lenses allow outdoor operation in hot climate areas, without requiring use of a cooling system.

In some embodiments of the invention, a lens formed of a polycarbonate, such as a polyaromatic carbonate or a polyaliphatic carbonate. Possibly, the lens is formed from the polycarbonate using an injection molded process.

An aspect of some embodiments of the invention relates to an indicia carrier having an alignment line printed thereon, within the area used for the images, optionally at a relatively unimportant side of the image. The alignment line is optionally of a size, color and/or shape which is noticeable by an installation technician aligning the indicia carrier, allowing fast alignment, while only minimally interfering with the viewing of the images. It has been determined in accordance with embodiments of the present invention that while the images move, the interference of the alignment line is substantially negligible.

In some embodiments of the invention, the alignment line is thinner than a single lens of the lens array, optionally even thinner than half a lens. For example, the line may have a width of about a quarter of a lens. Optionally, the line has a width of less than 1 mm, for example, between 0.4-06 mm. The line is optionally of a color which clearly stands out, so that it is noticed by the technician. Alternatively, a color which is less noticeable, so as to only minimally interfere, is used.

Using indicia carriers with alignment lines, the alignment of the indicia carrier is performed while the indicia carrier is stationary. The technician locates the line and moves the indicia carrier until the entire line can be viewed.

An aspect of some embodiments of the present invention relates to providing a weather-proof multi-image display device, for example a display device resistant to precipitation, condensation and/or extremes of temperature or solar illumination. In an exemplary embodiment of the invention, the display device is designed to take into account the effect of heat fluctuations, for example by controlling the direction of expansion, by providing a same amount of expansion for the lens, indicia carrier, indicia frame and/or drive mechanism and/or by compensating for environment-related distortions. A temperature sensor may optionally be provided for modifying the drive mechanism Alternatively, the drive mechanism may operate in a closed loop with the indicia, for example using an optical sensor, moving one strip disregarding the original width of the strip. Alternatively or additionally, an internal heater (with an optional thermostat) is provided, for example for heating the casing, lens, motion mechanism, alignment mechanism and/or indicia carrier. Such a heater may be, for example, a point heater or a surface heater, for example, a flat coil. For example, the display device may be designed to withstand temperature ranges of 10° C., 20° C., 30° C., 40° C. or more, with temperature extremes, for example, of −20° C. and +40° C. Also high humidity levels and humidity level extremes may be supported, for example, 80%, 90% or high relative humidity and extremes from of less than 30% or 15% humidity to above 90% humidity.

Alternatively or additionally, the positioning of the indicia relative to the lens is such that light from the sun does not focus on the indicia, for example, the indicia being more than one or even two focal lengths away from the lens. However, this is not required.

Alternatively or additionally, the lens array is provided with an anti-sun coating, to reduce the intensity of incoming light. Alternatively or additionally, a light collimator may be provided, to prevent light from impinging on the indicia from angles at which sunlight is expected. Alternatively or additionally, the lens array is formed with expansion holes or slot to accommodate temperature expansion effects and/or to prevent condensation or allow it to escape.

An aspect of some embodiments of the invention relates to providing a lens array display in which replacement of an indicia carrier is made simpler and/or faster.

An aspect of some embodiments of the invention relates to detection of misalignment and/or adjustment of the alignment between an indicia or a printed image and a lens array of a lens array display. Not all types of misalignment are addressed in every embodiment of the invention. Exemplary types of misalignment include relative parallelism and/or rotation of the lens, the indicia and/or the indicia path. The alignments may be zero order (offset), first order (linear) or even higher order. Thus, for example, in some embodiments of the invention, a misalignment of a lens is corrected by stretching the lens in a lens holder, effecting a first order alignment correction. An exemplary zero order correction is by moving and/or rotating the lens array. An exemplary second order correction is by providing multiple calibration screws along the lens, to allow twisting the lens array.

In some embodiments of the invention, a casing of the lens array display comprises an adjustment unit which is coupled to the indicia and/or the lens array. When a new indicia is inserted to the casing, the adjustment unit is used to align the indicia with the lens array. In some embodiments, the adjustment unit comprises a motor. Optionally, the motor (and/or at least some of its control circuitry) is detachable, and carried by people who service the displays and/or replace indicia. Alternatively or additionally, the adjustment motor is remotely controlled, for example allowing a person to view the display from a distance while performing alignments. In some embodiments, the transmission of the control signals to the motor is effected through wires, in others by wireless means, such as analog or digital electromagnetic radiation or ultrasonic signals.

In some embodiments of the invention, the lens array display comprises at least one alignment sensor which detects misalignments. In some embodiments of the invention, the at least one alignment sensor provides adjustment indications to the adjustment unit which automatically aligns the indicia responsive to the indications. Alternatively or additionally, the alignment sensor alerts a service person that the lens array display is misaligned, for example a local service person or a remote service person, optionally using a communication device (e.g., a cellular telephone or a radio).

In some embodiments of the invention, the alignment sensor comprises a camera which views a portion of the indicia through the lens array and circuitry, e.g., a processor, which determines whether the image viewed by the camera is acceptable. In some embodiments of the invention, the indicia have a test image printed on one of their corners (and/or at other locations thereof), and the camera is directed toward the test image.

In some embodiments of the invention, the lens array comprises a plurality of lens arrays. In such a case, a possible alignment is the relative alignment of the different lens arrays.

An aspect of the some embodiments of the invention relates to using a lens array of a single size for different magnification ratios of the displayed image, thus allowing different strip widths (and/or picture numbers) to be accommodated in a single device. In some embodiments of the invention, a casing of a lens array display comprises a plurality of slots for receiving the indicia at different distances from the lens array. Alternatively or additionally, the casing has a plurality of slots for inserting the lens array at different distances from the indicia. Alternatively or additionally, the distance between the indicia and the lens array is adjustable, for example using a screw mechanism.

An aspect of some embodiments of the invention relates to providing means of holding the indicia carrier substantially in place on the indicia carrier holder. For example, tensioning rods and/or spring devices are employed to reduce the freedom of motion of the indicia carrier, and to ensure that despite temperature changes the indicia is always taut and/or at the correct distance and/or correct orientation from the lens array.

An aspect of some embodiments of the present invention relates to using a relatively low precision lens array in a lens array display. In some cases, the use of lower precision will allow a lens array to be provided at a lower cost than previously considered possible.

In some embodiments of the invention, the low precision lens array is mounted in a casing which allows adjustment of the distance between the lens array and the indicia. The distance between the lens array and the indicia is adjusted so as to minimize the affect of the low precision lens array on the quality of the image displayed by the lens array display. In some embodiments of the invention, the adjustment is performed each time a new indicia is inserted to the casing. Alternatively, the adjustment is performed once for each lens array.

In some embodiments of the invention, the indicia are printed responsive to the properties of a specific lens array in which they are to be displayed. For example, if the lens array has a left tilt, the indicia is printed with a compensating or matching tilt. In some embodiments of the invention, a list of properties is produced for each lens array after its production. In printing a batch of indicia for a plurality of lens array displays, each indicia is printed separately with compensation properties matching the properties of the lens array with which the indicia is to be displayed. In some embodiments of the invention, each indicia is printed with identification of the lens array with which it is to be used, for example on a back side of the indicia.

In some embodiments of the invention, indicia are printed with redundant zones which compensate for the low precision of the lens array. In some embodiments of the invention, each strip of the indicia is printed twice in the indicia, such that, if the lens array slightly deviates in one direction, a portion belonging to the same image will be displayed rather than a portion from a strip belonging to a different image. Alternatively, each strip has a width wider than is meant to be displayed and the printed strips overlap. In case the lens array deviates from its planned orientation it will display a portion of the same image, rather than a portion of a different image.

An aspect of some embodiments of the present invention relates to a lens array display in which the motion function of the indicia relative to the lens array is controllable. In some embodiments of the invention, a maintenance person may set the rate at which the displayed images change. In some embodiments of the invention, the display time of different images may be different, such that some images are displayed for longer periods than others. Alternatively or additionally, some images are displayed (or their display time varied) at certain hours while others are displayed at other hours. For example, at times in which children are expected to pass near the display, advertisements directed to young consumers are displayed at a high intensity and/or display time, while at other times advertisements directed to older consumers are displayed with a high intensity and/or display time. Alternatively or additionally, the image step is modified, for example for calibration purposes. It should be noted that a plurality of images can be provided on a single indicia, with only some of the images being used for display cycling at any given time, by suitable controlling the motion function.

In some embodiments of the invention, the motion function of the indicia is planned to operate using a redundancy pattern of the indicia to compensate for low precision of the lens array. In some embodiments of the invention, in inserting an indicia, a maintenance person enters a motion function of the indicia into a controller. Alternatively or additionally, the controller automatically reads an indication of the motion function which should be used, from the indicia, for example, using a bar-code. Alternatively or additionally, the display may be remotely controlled and/or programmed. Additional or alternative indications, such as bar-codes, may be provided to mark strips and/or for providing other programming information to the display device.

An aspect of the present invention relates to using large width lenses in a cylindrical array, for example lens having a width of above 11 mm, particularly above 15 mm. In some cases, the use of such wide lenses allows the use of relatively low precision indicia, for example 24 Dots Per Inch, so that lower resolution indicia printing methods may be used. In some cases, the use of lower precision indicia will allow the indicia to be provided at a lower cost than previously considered possible. The lens may be a Fresnel lens array or a plain lens array, for example.

An aspect of some embodiments of the present invention relates to a lens array display kit for installing in existing (e.g., non-alternating) display casings. In some embodiments of the invention, the lens array and indicia are packaged together in a manner which allows easy attachment to the existing display casing. In some embodiments of the invention, the display kit also includes a drive mechanism for driving the indicia and/or lens array and/or an adjustment unit. Optionally, the display kit comprises a lens array and an indicia holder which are fixedly oriented relative to each other. Alternatively, the lens array display kit allows simple orientation of the lens array and indicia holder within the existing casing. In one exemplary embodiment, the display kit includes lighting apparatus. Alternatively or additionally, lighting apparatus is provided by an existing casing of the display.

There is thus provided in accordance with an exemplary embodiment of the invention, a display device, including an image selector, for selectively displaying images of a multi-image indicia carrier, a back board, a motor that provides relative movement between the board and the image selector and an indicia carrier detachably placed between the image selector and the back board, such that it moves with the back board, at least partially due to a non-interlocking coupling of the indicia carrier to the back board.

Optionally, the friction level between the board and the indicia carrier is substantially higher than the friction level between the image selector and the indicia carrier.

Optionally, the indicia carrier moves with the back board mainly due to the high friction level between the indicia carrier and the board.

Optionally, the friction level between the indicia carrier and the board is at least twice or even ten times the friction level between the indicia carrier and the image selector.

Optionally, the board is moved by the motor and the image selector remains stationary.

Optionally, the image selector is moved by the motor and the board remains stationary.

Optionally, the indicia carrier is not coupled to the board in any way except for the high friction level. Optionally, the indicia carrier is attached to the board by at most four interlocking elements. Optionally, the indicia carrier is attached to the board using interlocking elements only along one side of the board. Optionally, the indicia carrier comprises an image sheet laminated in a manner which provides substantially different friction levels on its opposite faces.

Optionally, the image sheet is laminated with different materials on different faces. Alternatively or additionally, the image sheet is finished with different methods on different faces. Alternatively or additionally, the indicia carrier comprises a plastic base which is smoothed on an image face and is rough on the opposite face.

Optionally, the board comprises a spongy material at least on its face against the indicia carrier. Alternatively or additionally, the board comprises a foam material at least on its side facing the indicia carrier.

Optionally, the board covers at least 90% of the area of the indicia carrier.

Optionally, the indicia carrier comprises a sheet which can be rolled into a cylinder having a diameter smaller than a fifth of the length of the indicia carrier, before being inserted into the display device. Optionally, the indicia carrier does not include a rigid frame.

Optionally, the back board pushes the indicia carrier against the image selector.

Optionally, absent the non-interlocking coupling the indicia carrier would not move with the back board or would be distorted. Optionally, the back board has a mesh structure. Optionally, the back board is coated with PVC or silicon on a side facing the indicia carrier.

There is further provided in accordance with an exemplary embodiment of the invention, a display device, comprising an image selector, for selectively displaying images of a multi-image indicia carrier, an indicia carrier holder, a motor that provides relative movement between the indicia carrier holder and the image selector and a fan adapted to blow air in the vicinity of an indicia carrier held by the indicia carrier holder.

Optionally, the display includes a heater adapted to heat air blown by the fan. Optionally, the display includes a thermostat adapted to operate the fan at predetermined temperature levels. Optionally, the fan is positioned to blow air upwards along at least 20% of the height of the indicia carrier.

There is further provided in accordance with an exemplary embodiment of the invention, a display device, comprising an image selector, for selectively displaying images of a multi-image indicia carrier, an indicia carrier holder, a motor that provides relative movement between the indicia carrier holder and the image selector, a cooling mechanism adapted to cool an indicia carrier held by the indicia carrier holder and a power source adapted to power the cooling mechanism. Optionally, the cooling mechanism comprises a fan.

There is further provided in accordance with an exemplary embodiment of the invention, a display device, comprising an image selector, for selectively displaying images of a multi-image indicia carrier, an indicia carrier holder and a motor that provides relative movement between the indicia carrier holder and the image selector, wherein the image selector is formed from a material which does not distort in a manner which substantially impedes its optical properties at temperatures below 100° C. Optionally, the image selector is formed from a polycarbonate. In some embodiments, the image selector is formed from a material which does not distort at temperatures below 120° C. Optionally, the image selector has an area of at least 0.5 square meters.

### BRIEF DESCRIPTION OF THE DRAWINGS

The present invention will now be described in the following detailed description of exemplary embodiments of the invention and with reference to the attached drawings, in which same or similar number designations are maintained throughout the figures for each element and in which dimensions of components and features shown in the figures are chosen for convenience and clarity of presentation and are not necessarily shown to scale. Generally, only structures, elements or parts that are germane to the discussion are shown in the figures. The figures are listed below.

FIG. 1A is a blown-up schematic view of some of the elements of a cylindrical lens multi-image display mechanism;

FIG. 1B is a schematic drawing of an indicia carrier partially inserted into an indicia carrier holder, in accordance with an embodiment of the invention;

FIG. 1C represents an indicia for the display of two pictures, in accordance with an embodiment of the invention;

FIGS. 1D and 1F show the pictures encoded in the indicia of FIG. 1C;

FIG. 2 is a schematic drawing of the indicia carrying frame in accordance with an embodiment of the invention;

FIG. 3 shows a general view of a street display unit which is fitted into an existing street sign, being aligned after indicia carrier change, in accordance with an embodiment of the invention;

FIG. 4 shows an alternative drive mechanism, using a universal joint, in accordance with an embodiment of the invention;

FIG. 5 is a schematic view of a second embodiment using a worm screw assembly for alignment correction, in accordance with an embodiment of the invention;

FIG. 6 shows another mechanism using a worm screw assembly for alignment correction, with a detachable motor, in accordance with an embodiment of the invention;

FIG. 7A shows an eccentric bar alignment drive, in accordance with an embodiment of the invention;

FIG. 7B shows a display device suitable to the eccentric bar alignment drive of FIG. 7A, in accordance with an embodiment of the invention;

FIG. 7C shows schematically an alternative alignment mechanism, in accordance with an embodiment of the invention;

FIG. 7D shows a frontal detail of the alignment mechanism of FIG. 7C, in accordance with an embodiment of the invention.

FIG. 7E shows the detail of FIG. 7D from a viewpoint perpendicular to that of FIG. 7D.

FIG. 8 shows an indicia carrier backing, in accordance with an embodiment of the invention;

FIG. 9 shows pins upon which the indicia carrier backing of FIG. 8 is fastened;

FIG. 10 is a schematic view of a display unit, in accordance with an exemplary embodiment of the invention;

FIG. 11 is a cross-sectional view of a display unit, in accordance with an exemplary embodiment of the invention;

FIG. 12 is a schematic illustration of a lower portion of a back board of a display device, with a manifold fan, in accordance with an exemplary embodiment of the invention;

FIG. 13 is a schematic illustration of a back board with fans mounted thereon, in accordance with an exemplary embodiment of the invention; and

FIG. 14 is a schematic illustration of a remote control unit, in accordance with an exemplary embodiment of the invention.

### DETAILED DESCRIPTION OF SOME EMBODIMENTS

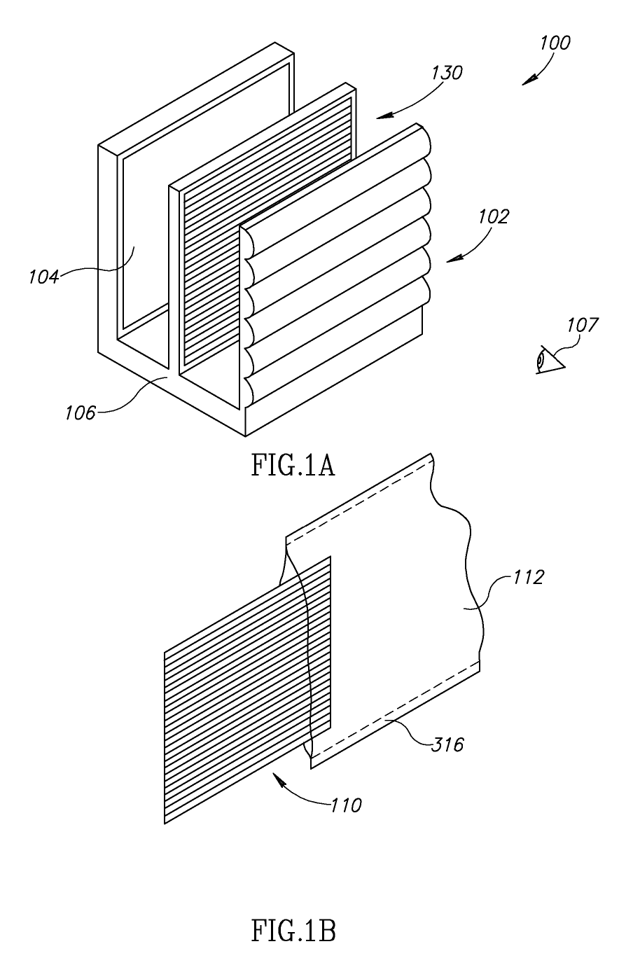

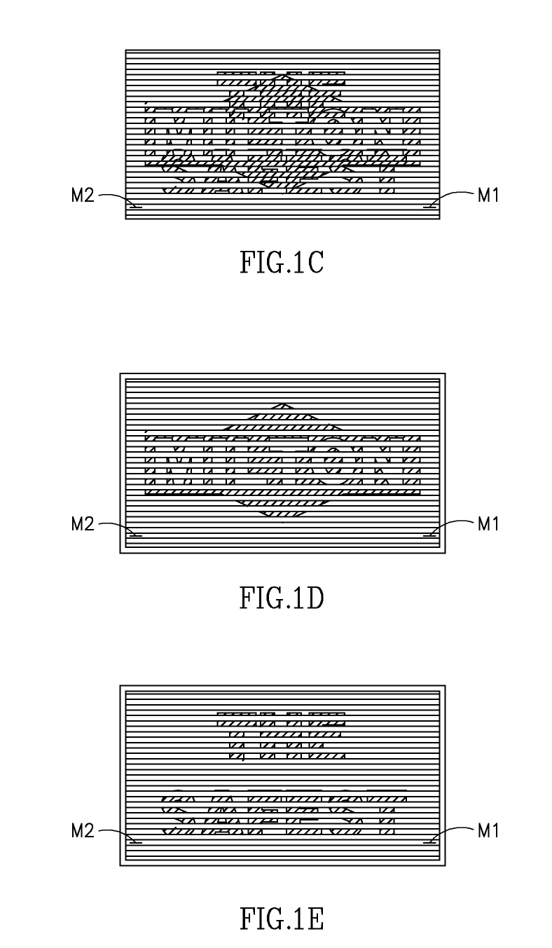

FIG. 1A schematically illustrates, in blow-up view, a portion of a multi-image display device 100, in accordance with an exemplary embodiment of the invention. Display device 100 may be of substantially any size. It is noted, however, that the features of display device 100 described hereinbelow, facilitate the use of display device 100 for displaying images larger than one square meter or even larger than two, four or even eight square meters.

In some embodiments of the invention, multi-image display device 100 is adapted for use as a street sign. Optionally, display device 100 has a weather proof casing (not shown) which protects the display device from outdoor conditions, such as temperature changes, rain, snow and vandals.

Coupled to a fixed frame 106 are a cylindrical lens array 102 and an indicia carrying frame 130. Frame 130 carries an indicia, encoding a plurality of images, printed on indicia carrier 110. FIG. 1C shows an exemplary indicia carrier 110, and FIG. 1D and FIG. 1E show respectively the two pictures encoded in indicia carrier 110. On the indicia in FIGS. 1C, 1D and 1F markings M1 and M2 are visible. Markings M1 and M2, which are made for the purpose of manually and/or automatically aligning indicia carrier 110, are related to below.

The images encoded in the indicia are seen by a viewer indicated by an eye 107 looking through lens array 102. In order to switch the image viewed by the viewer, indicia carrier 110 (shown in FIG. 1B) moves relative to lens array 102. In some embodiments of the invention, indicia frame 130 moves relative to fixed frame 106 and lens array 102. Alternatively or additionally, lens array 102 moves relative to fixed frame 106 and indicia frame 130. Further alternatively or additionally, indicia carrier 110 moves relative to indicia frame 130.

An optional light source 104 illuminates indicia carrier 110 from behind. Alternatively or additionally, light sources are located between indicia carrier 110 and lens array 102 and/or before lens array 102 and/or on a side of frame 106. Further alternatively, device 100 does not include an internal illumination source, for example using ambient reflected or transmitted light.

FIG. 1B is a schematic illustration of indicia carrier 110 within an indicia carrier holder 112, in accordance with an exemplary embodiment of the present invention. In some embodiments of the invention, indicia carrier holder 112 comprises an envelope, transparent at least on the side which lies between indicia carrier 110 and lens array 102. The other side is optionally translucent, to diffuse the light which illuminates the indicia from behind. In some embodiments of the invention indicia carrier holder 112 utilizes such a structure to enable quick change of indicia carrier 110. In some embodiments of the present invention, there are sleeves 316 at the edges of indicia carrier holder 112, by which indicia carrier holder 112 is held in place.

In some embodiments of the invention, indicia carrier 110 is removably located within indicia carrier holder 112 so that it can speedily be replaced. Sometimes indicia carrier 110 is free in indicia carrier holder 112, held merely by friction. Alternatively indicia carrier 110 is held in place inside indicia carrier holder 112 by mechanical means, for example clamps. Alternatively or additionally, indicia carrier holder 112 may be equipped with a holding and/or clamping mechanism. In some embodiments indicia carrier 110 is attached to indicia carrier holder 112 at multiple points to allow stretching, for example in a case where expansion of lens array 112 is allowed for. Alternatively or additionally, indicia carrier holder 112 is removably held by indicia frame 130.

In some embodiments of the invention, indicia frame 130 comprises an alignment mechanism, as described below. Indicia frame 130, upon insertion of a new indicia carrier 110 into indicia carrier holder 112, aligns the axes of indicia 110 parallel to the focal axes of lens array 102.

Optionally, lens array 102 is formed of flat glass, having a thickness of at least 3 mm, 5 mm or even at least 6 mm. Alternatively, a thin glass is used for lens array 102, for example having a thickness of les than 4 mm or even less than 2.5 mm.

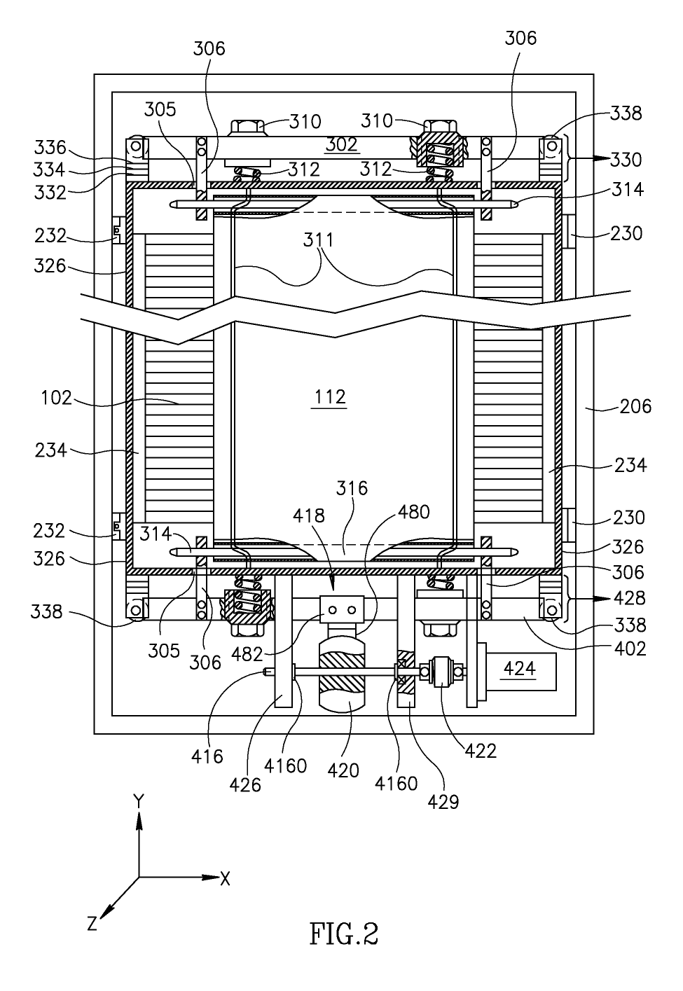

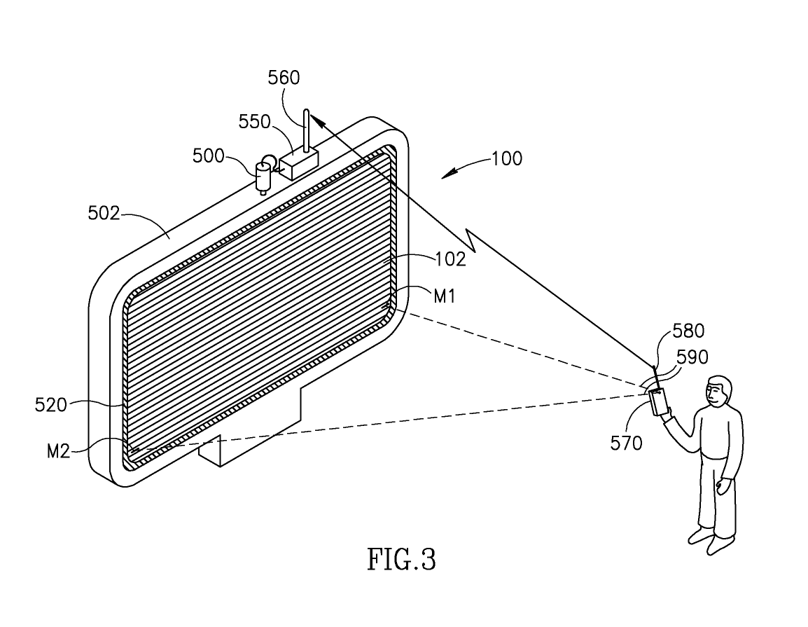

FIG. 2 is a schematic illustration of the rear side of some embodiments of the present invention, which can fit into an existing street sign housing 206. One can see sections of lens array 102, partially hidden behind indicia carrier holder 112. Lens array 102 is, for example, firmly but elastically held by lens holders 234 which are fastened to frame 326. The elasticity of lens holders is optionally obtained by lens holders 234 having a rubber lining. Thus lens array 102 may expand or contract with temperature changes. Optionally, lens array 102 is non-elastically held at least on one or two sides, thus directing the expansion and contraction of lens array 102. Lens holders 234 may also serve to damp vibrations, for example from roadways or wind. Alternatively or additionally, other vibration dampers may be provided. Optionally, the vibration response characteristics of the indicia carrier and of the lens are matched, for example, by matching the weight and/or adding dampers, as known in the art of damping, so that they will have a similar response. Alternatively or additionally, the indicia and the lens are coupled so that they will vibrate in synchrony.

In one embodiment of the invention, lens array 102 is stretched by lens holder 324, in order to effect a matching of lens array to indicia carrier 110. The stretching is optionally performed actively, for example using a motor that stretches the lens holder. Alternatively or additionally, the stretching is passive, for example by manual screws that hold lens array 102 in a stretched configuration. The stretching may be uniform Alternatively, a plurality of screws are provided in the frame, to allow different stretching of different parts of the lens. Optionally, differential tightening of the screw can be used to effect various distortions and rotations of the lens, for example, with some screws controlling an in-plane displacement of the screwed portion and other screws controlling an out-of-plane displacement. Optionally, the lens are pre-stretched to the geometry caused by a given temperature.

It should be noted that aligning frames holding lens array 102 and indicia carrier 110 rather than lens array 102 and indicia carrier 110 themselves may be desirable in some embodiments, as stress on functioning elements is thus reduced and/or evenly distributed.

In an exemplary embodiment of the invention, lens array 102 is provided as multiple lens sections. Each such section is optionally aligned and/or distorted on its own. Alternatively or additionally, alignment between the different sections is provided, for example, each section being held by a different lens holder, with an inter-lens holder alignment mechanism provided.

Frame 326 is connected by fasteners 230 and fasteners 232 to housing 502. Optionally fasteners 230 are hinge sections which fit the door hinges of a previously existing street sign. In some exemplary embodiments, the original door is removed, as is the light diffusing panel if such panel exists, and the upgrade display unit of the present invention is inserted to the existing housing. The inserted display unit is fastened, for example, by using the existing door hinges, as stated above, on one side, and fasteners 232 on the other. Fasteners 232 are preferably operated by a screw which presses a part of fastener 232 against the side of existing frame 206. Alternatively or additionally, other fastening means, such as clamps or pressure fittings may be used.

An indicia carrier drive mechanism described in the following paragraphs moves indicia carrier holder 112 within fixed frame 326, thus changing the images seen by the viewer. The type of drive mechanism may vary between different implementations, for example, being electrical motor, solenoid, linear actuator, piezoelectric, pneumatic, hydraulic, spring operated, weight operated, pendulum operated and/or clockwork operated drive mechanisms. The power source can be, for example, line, battery or solar electrical power, wind power and/or mechanical power, for example internal as a spring or external, as vibrations.

The drive mechanism optionally has a maximal stroke of between about 6-8 mm, for example about 6.5 mm. The speed of the drive mechanism is optionally less than 3 mm/sec, optionally less than 1.5 mm/sec. In some embodiments of the invention, a speed of at least 0.01 mm/sec, optionally at least 0.033 mm/sec is used.

The indicia carrier drive mechanism, which raises and lowers lower bar 402, optionally comprises a motor 424, coupling 422, drive shaft 416, cam 420, and cam follower 418. These parts are supported from fixed frame 326 by drive shaft supports 426 and motor support 429. Two retaining devices, for example Circlips 4160, one on each side, keep drive shaft 416 in place. Cam follower 418 is a slider assembly made of two pieces. Part 480, which has a preferably spherical surface, is in contact with preferably spherical cam 420. Part 482 is attached to lower mechanism bar 402 which is otherwise analogous to upper bar 302. As motor 424 turns cam 420, lower bar 402 is raised and lowered relative to fixed frame 326, raising and lowering holding pieces 306 which pass through openings 305 in fixed frame 326. Holding pieces 306 hold bars 314 which pass through sleeves 316 at the edges of indicia carrier holder 112. The resulting motion of indicia carrier 110 held in indicia carrier holder 112 relative to fixed frame 326—and hence relative to lens array 102—changes the particular picture encoded in the indicia which is currently displayed, and the viewer sees a different image. Indicia carrier holder 112 is optionally kept in tension during the motion, for example, by springs 312 and/or by tension rods 311. Tension rods 311 are optionally tightened by screw mechanisms or other means as known in the art.

FIG. 2 also shows an upper mechanism 330, in accordance with an embodiment of the present invention. Optionally, bar 314 is attached to an upper bar 302, for example, by two support bars 306 which pass through openings in frame 326. Two sets of special nuts 310 and optionally springs 312 connect upper bar 302 to structural element 326. Nuts 310 screw into screw-holes in bars 302 and 402, and pass through bars 302 and 402 respectively. Springs 312 are firmly connected to frame 326, preferably by welding one end. The other end of springs 312 are moveably located inside a recess in special nut 310. Thus, nut 310 and spring 312 form an adjustable screw mechanism held in tension by spring 312. This screw mechanism both holds indicia carrier holder 112 in tension to prevent slippage and/or disorientation and enables aligning of indicia carrier 110. When the two adjustable screw mechanisms are tightened equally, the distance between fixed frame 326 and upper bar 302 is reduced. However, if nuts 310 are unequally tightened, upper bar 302 turns around the Z axis. When upper bar 302 turns around the Z axis—indicia carrier holder 112 is rotated, and the orientation of the axes of the indicia relative to the focal axes of lens array 102 is changed.

FIG. 2 also shows a lower mechanism 428, in accordance with an embodiment of the present invention. The lower mechanism 428 in FIG. 2 contains parts substantially equivalent to those of upper mechanism 330, and have been identified with the same numerals.

In some embodiments of the invention, upper bar 302 and lower bar 402 are, on both sides, in contact with pulleys 338. Bars 302 and 402 move in the Y direction within slots of pulleys 338. Pulleys 338 are adjustably fastened to structural element 326 via adjustment pieces 332, 334 and 336. Pieces 332, 334 and 336 respectively control adjustment of the end of bars 302 and 402 in the directions of the X, Y and Z axes relative to frame 326, as hereunder. Piece 336 can turn around the Y axis. Piece 336, in turn, is connected to Piece 334. Piece 334 can be moved along the Z axis. Piece 334 is connected to Piece 332; Piece 332 can be moved along the X axis. Piece 332, 334 and 336 together enable the adjustment of upper bar 302 with regard to three degrees of freedom: X, Z and θy (the angle of turning around the Y axis).

In some embodiments, a corner fastener is used instead of pieces 332, 334 and 336. With this method frame 106 may be quickly disassembled.

The need for adjustment or relative orientation of the parts of the display apparatus mechanism may result, for example, due to imperfections of the original manufacture of the display device, by handling caused by indicia changing, by physical impact on the display device, by road vibrations and/or by temperature changes. The misalignment may be, for example, misalignment of the structure of the display device.

In particular, the misalignment may include, for example, the indicia carrier not being parallel to the lens array, and/or misalignment of the lens in the display unit, and/or misalignment of the direction of the relative motion between the lens array and the indicia carrier. Alternatively or additionally, the misalignment may be caused by inaccurate placement of the indicia carrier when the pictures are changed. Misalignment may be attributable to imperfections in an indicia preparation process. Additionally or alternatively, any one or any combination of the following parameters may be outside their respective tolerances: the distance between the indicia and the lens, the relation of the width of the linear segments on the indicia and the distance between focal lines of the lens, the matching of the distance between linear segments and the amount of motion of the lens for picture changing.

In some embodiments of the invention, the alignment of indicia carrier holder 112 (not shown in the figure) is effected as shown in FIG. 3. FIG. 3 shows a street sign 100 in which indicia carrier 110 (not shown in the figure) has just been changed or is unaligned for other reasons. It is noted that the direction of insertion of the indicia carrier may be parallel or perpendicular to the lens axis. Alternatively or additionally, the lens may be opened as a hinged door and the indicia carrier placed in the frame.

In some embodiments, the axes of the lens elements of cylindrical lens array 102 are horizontal, as shown in FIG. 3. In such an embodiment the motion of indicia carrier 110 is typically vertical. Alternatively the axes of the lens elements of cylindrical lens array 102 are vertical, and the motion of indicia carrier 110 is, for example horizontal. Some embodiments use cylindrical lens arrays which are neither vertical nor horizontal, but whose lens axes are diagonal and/or curved.

In FIG. 3, the street sign displays an exemplary indicia carrier with two marks: M1 and M2, located close to the edges of the indicia carrier, yet in the area visible through lens array 102, in accordance with some embodiments of the present invention. The straight line between Marks M1 and M2 are substantially parallel to the axes of the strips which comprise the indicia. Marks M1 and M2 are printed on indicia carrier 110, in some embodiments, by an additional printing process after finishing the printing of the indicia, although in an exemplary embodiment marks M1 and M2 are printed or deposited by the same process which encodes and prints the indicia. One method is to code for marks M1 and M2 in the computer program which prints the indicia, for example using the printing process described in U.S. Pat. No. 5,100,330, the disclosure of which is incorporated herein by reference.

When M1 and M2 are both visible through the same lens of lens array 102, indicia carrier 110 is properly aligned. In some embodiments, the function of viewing marks M1 and M2 and deciding in which direction to turn nut 310 can be effected by a remote control device 570. Control unit 570 is held by the service person. Control device 570 transmits signals generated by a signal generating device, which is optionally part of control device 570, to a signal receptor 560. The signal received by signal receptor 560 is decoded by control device 550. Control device 550 sends impulses to servo-motor 500 which effects the alignment of indicia carrier 110 as described hereunder.

Servo-motor 500 shown in FIG. 3, turns (by a mechanism not shown) one or more of nuts 310 (for example as shown in FIG. 2) or other alignment mechanism that may be used, responsive to a command received as described above. In some embodiments of the invention, the screw turning commands are issued remotely. Thus, when display device 100 comprises a street sign, a person aligning indicia carrier 110 may issue commands to turn one of the nuts 310 while standing at a distance from display device 100. For example, the user may stand at a distance from display device 100 which allows the user to see the entire display device at once and to notice a possible misalignment of the indicia relative to lens array 102.

In some embodiments of the present invention, control unit 570 has sensors 590 which sense the positions of marks M1 and M2. In some embodiments of the present invention a calculating unit, which may be housed in control unit 570, calculates the correcting movement necessary to align indicia carrier 110. In some embodiments of the present invention the needed correcting movement as calculated is displayed for the user. In some embodiments a sending device 580 which may be housed in control unit 570, sends appropriate control signals through signal sending device 580 to motor control device 550.

Alternatively to using two alignment lines, a single vertical alignment line is used. The alignment line is optionally in a bright color which is not too outstanding when not searched for, such as yellow. In some embodiments of the invention, the single alignment line is located within the image area of the indicia carrier 110, for example between two image stripes of different images. After inserting a new indicia carrier 110 into display device 100, the indicia carrier is moved using the remote control until at least a portion of the alignment line is viewed by a technician installing the indicia carrier 110. Thereafter, using the remote control, the alignment of the indicia carrier is adjusted, until the entire line is viewed by the technician. The drive mechanism is then operated, so that the images displayed change. It is noted that due to the movement and/or the bright color of the alignment line, the alignment line is not noticed by casual viewers. Alternatively to using a vertical alignment line, a horizontal alignment line is used.

Alternatively or additionally to providing alignment marks, instructions may be printed on the indicia carrier. Such instructions may be, for example instructions to the installer, for example for manual calibration, parameter set-up and/or target display device. Alternatively or additionally, the instructions may be for an automated calibration controller, for example in machine readable form such as bar-codes. For example, the instructions can include one or more of initial alignment settings, desired magnification, motion profile (e.g., image order, display time), expected alignment quality, existence and/or type of alignment marks, printing process used and/or lens properties.

In some embodiments, the front surface of an existing static display 502 is replaced by the present invention, as shown in FIG. 3. A connecting element, such as a gasket, preferably a standard gasket, or a cowling 520 connects fixed frame 106 (of FIG. 2, not visible in FIG. 3) to a housing of existing street sign 502. Additionally or alternatively, frame 106 has attachment devices to attach to the housing. Connecting element 520 optionally weatherproofs the street sign, and, optionally having baffles, allows humidity to escape.

Different levels of integration may be provided, with the display sharing various elements with the existing signs. For example, the sign and the display can share one or more of a base, a frame, power sources, lighting elements, remote controls and/or a processor. In some embodiments of the invention, converting a static display into a multi-image dynamic display includes adding a temperature affecting unit, such as a fan or heater, which affects the temperature within display device 100, so as to prevent distortion of lens array 102 and/or indicia carrier 110 due to extreme and/or uneven temperatures.

Optionally, the display device is designed to fit into existing standard sign sizes. Alternatively, an adjustable coupling element 520 is used.

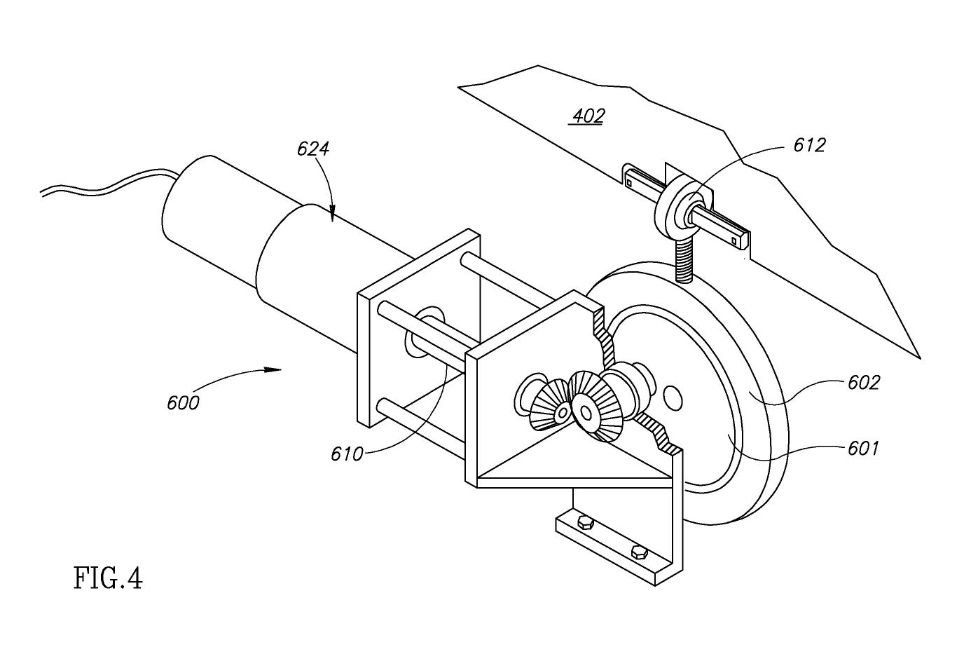

FIG. 4 is a schematic illustration of an exemplary display drive mechanism 600, in accordance with an embodiment of the present invention. Display drive mechanism 600 may be used instead of cam 420 which was described above with reference to FIG. 2. Drive mechanism 600 includes a cam 601, optionally a circular disk, which is eccentrically mounted on a drive shaft 610 of a drive motor 624. A sliding ring 602 is mounted on cam 601, and the handle of a universal joint 612 is screwed into sliding ring 602. A ball end of universal joint 612 is connected to lower bar 402, which moves indicia carrier holder 112. Alternatively, cam 601 is indirectly coupled to drive shaft 610.

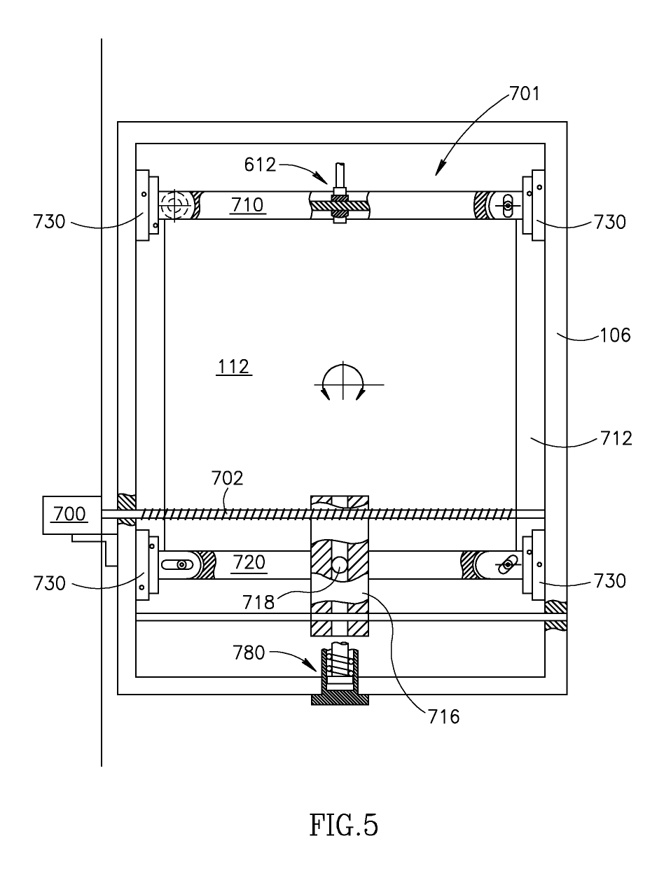

FIG. 5 is a schematic illustration of an indicia frame 701, moveably held by sliders 730 and moving inside fixed frame 106, in accordance with an embodiment of the present invention. Indicia frame 701 comprises indicia carrier holder 112, bars 710 and 720 which hold and move indicia carrier holder 112, and, in various embodiments including those embodiments described herein, all mechanisms shown or described as being connected to and moving with bars 710 and 720. Indicia frame 701 is analogous to indicia frame 130, described above with reference to FIG. 1A.

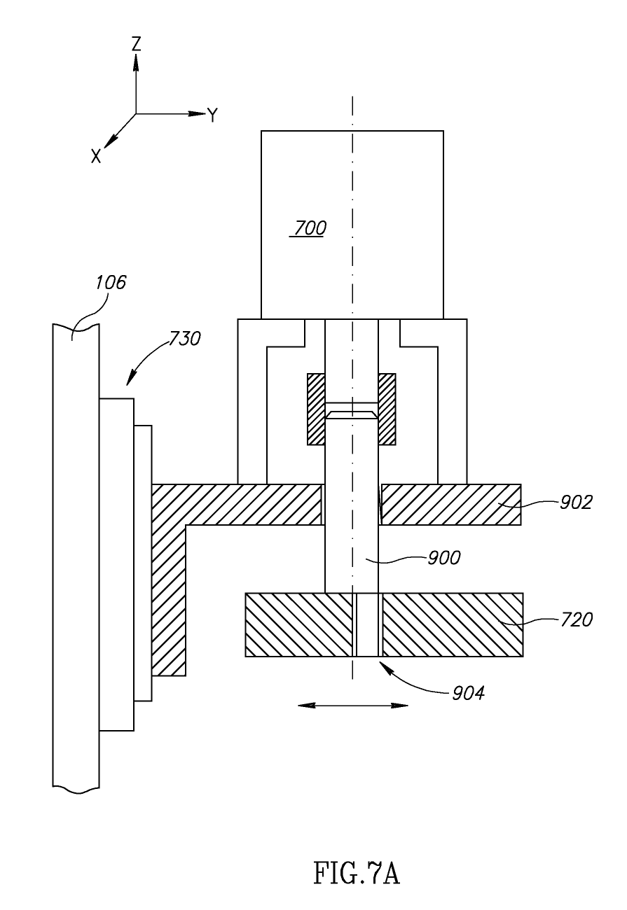

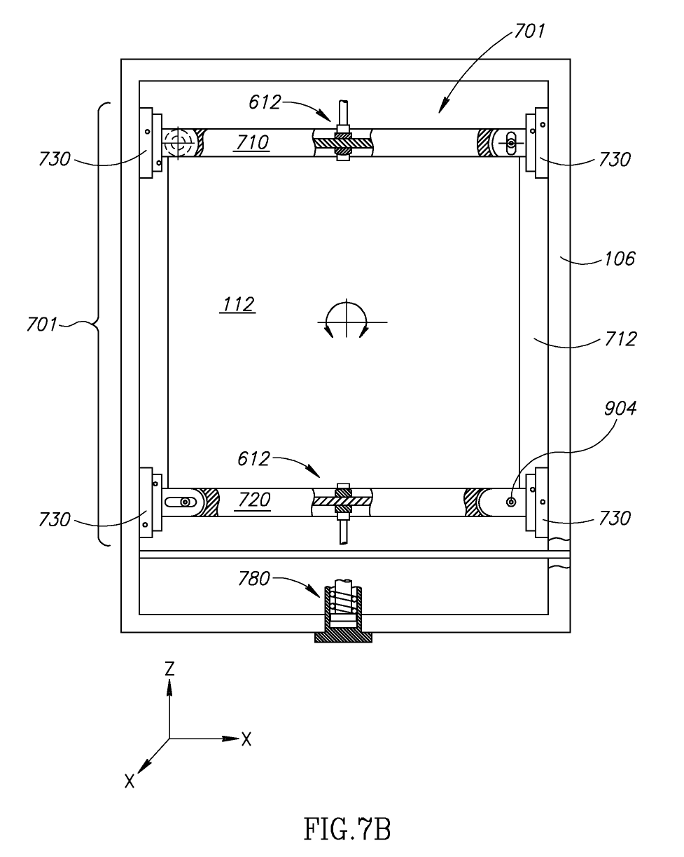

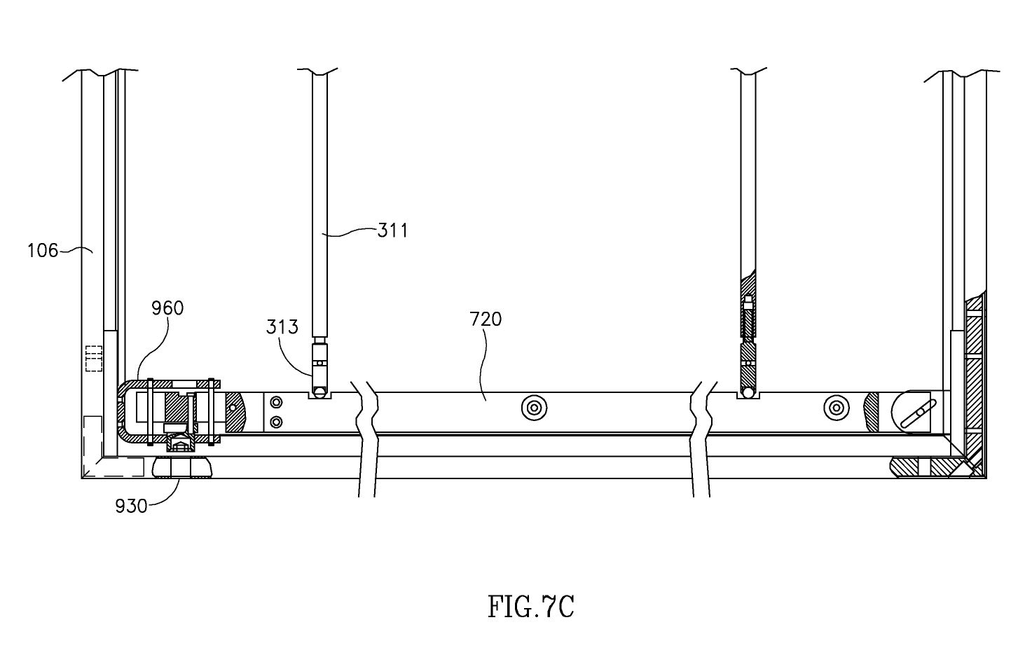

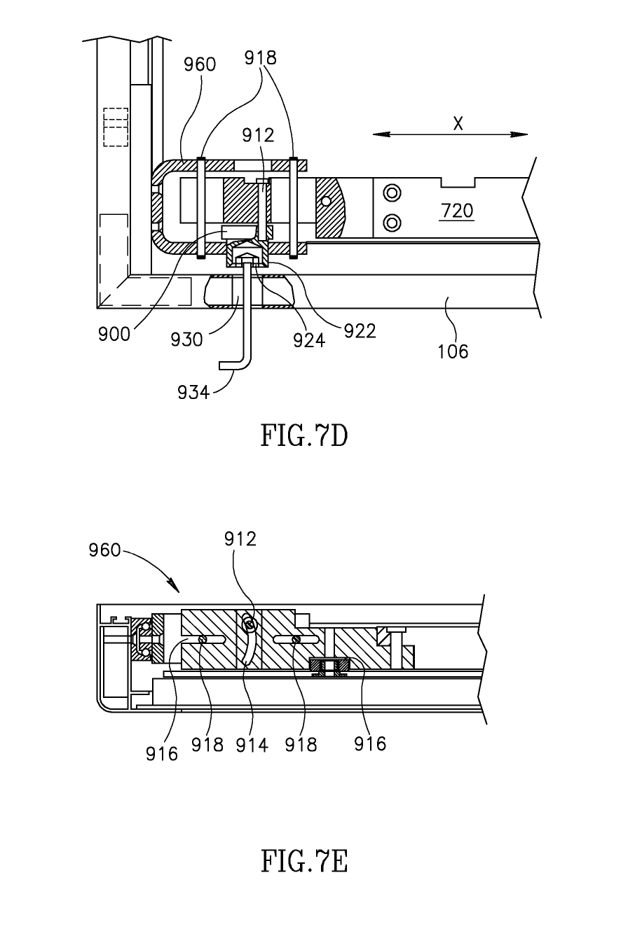

A worm-screw bar 702 is driven by servo-motor 700, and the resulting linear motion of part 716 forces pin 718 to move to the left or to the right, depending on the turn of worm-screw bar 702. Part 718 is firmly connected to bar 720 which moves horizontally, but also vertically at the right end in FIG. 5. The vertical movement of bar 720 causes vertical movement of bar 712, which in turn causes vertical movement of the right end of bar 710. Thus the right side of indicia carrier holder 112 is raised or lowered more than the left side, resulting in the turn of indicia carrier holder 112. Indicia carrier holder 112 is attached to bars 720 and 710 which are analogous to bars 302 and 402, as described above in relation to the embodiment shown in FIG. 2. Bar 710 is driven by a drive motor, in some embodiments as in FIG. 4, which is connected to bar 710 by universal joint assembly 612 as shown in FIG. 4. Alternatively, other drive mechanisms may be used. At the bottom of FIG. 5, located on base 106, is a spring assembly 780 holding the end of a universal joint. This will be further explained with reference to FIG. 7B below.

Alignment motor 700 in FIG. 5 is fixed in some embodiments, but in some embodiments is detachable, since it is needed only to correct orientation after change of indicia. Alternatively, the alignment is by manual turning of screws or other adjustment knob types.

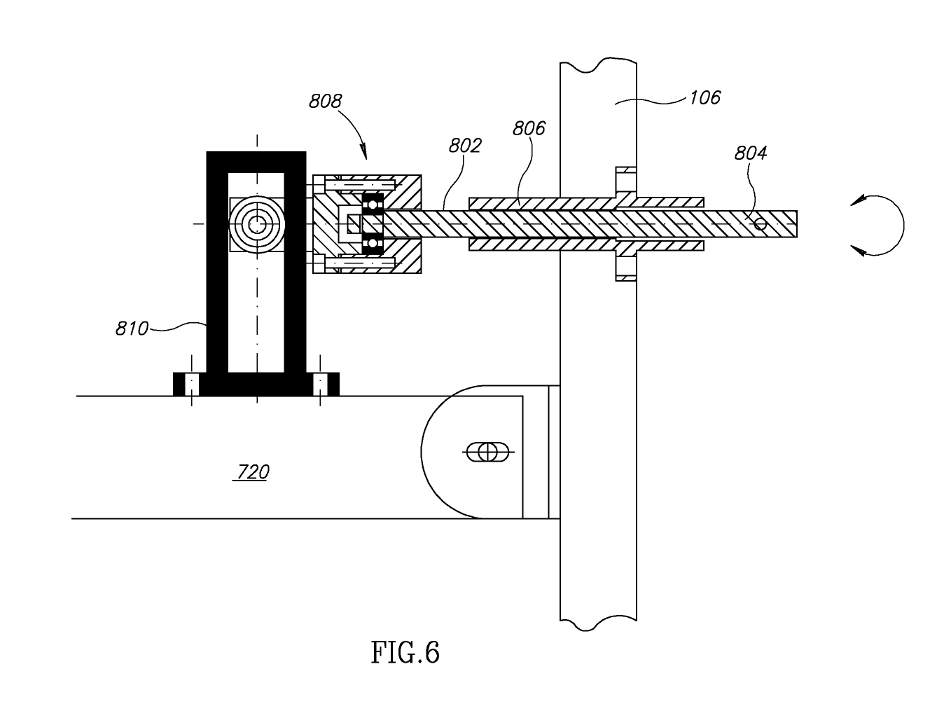

FIG. 6 shows an alternative alignment mechanism to which an external motor may be attached. A worm screw 802 acts similarly to worm screw 702. At the end of worm screw 802 there is a connecting bar 804. Connecting bar 804 passes through a sleeve 806. Sleeve 806 passes through and is fastened firmly to the side of frame 106 of display unit 100. To align the orientation of the indicia carrier a motor (not shown, analogous to motor 700 in FIG. 5) is attached at the end of connecting bar 804. The motor turns connecting bar 804, which, by turning, moves parts 808 and 810, thus moving bar 720 as in the previous embodiment.

FIG. 7A shows an alternative alignment mechanism. Servo-motor 700 is affixed to holding piece 902. Alignment eccentric 900 passes through an opening in holding piece 902. The end of alignment eccentric 900 is movably located in cavity 904 in bar 720. When servo-motor 700 turns, the end of alignment eccentric 900 executes eccentric motion, thus moving bar 720 back and forth. In FIG. 7B holding piece 902 is shown with cavity 904 facing the viewer of FIG. 7B. This mechanism, in which all alignment parts are carried with moving indicia carrier holder 112, enables alignment of indicia carrier 110 while the display device is operating.

FIG. 7B shows bar 710 with universal joint 612, which, as in FIG. 5 connects to a drive mechanism (not shown). In bar 720 there is another, substantially similar, universal joint 612, which connects to spring assembly 780. Spring assembly 780 ensures that indicia carrier holder 112 is under tension, to prevent slippage of indicia carrier 110.

FIG. 7C, FIGS. 7D and 7E schematically show an alternative alignment mechanism. This differs functionally from that described in FIG. 7B in that the motion of bar 720 is limited to motion in the X direction. FIG. 7C shows fixed frame 106 as in FIG. 1A, FIG. 2 and FIG. 5, bar 720 as in FIG. 5, and tension rods 311. Here also illustrated are tension rod tightening devices 313, optionally comprising screw mechanisms.

In embodiments utilizing this mechanism, a connecting section 960 connects bar 720 to sliders 730 which connect to and move in frame 106. Connecting section 960 is provided with a curved groove 914 and straight grooves 916.

Pin 912 protrudes from eccentric 900 into curved groove 914, as shown in FIG. 7E. Pin 912 is eccentrically held by eccentric cam 900 in some embodiments, or is eccentrically attached to it in other embodiments, or manufactured with the cam as one complete part in other embodiments.

When eccentric cam 900 turns, pin 912 moves in groove 914, causing horizontal motion of bar 720. Pins 918, moving in constraining grooves 916, constrain the motion to the X direction. The movement of bar 720 in the X direction in embodiments using this apparatus results in the same chain of movements as described in the description of the embodiment shown in FIG. 5 above, thus adjusting the orientation of indicia carrier 110 relative to lens array 102.

In some embodiments, the adjustment of the orientation of the indicia is performed by turning an eccentric cam 900 using the following mechanism: Eccentric cam 900 is attached to a flange having an extension 922 which has an attaching fixture 924, optionally in the form of a depression. Possibly, depression 924 is not round, but shaped, for example in the shape of a hexagon, to enable the insertion of a turning instrument 934, for example an Allen-type key. Extension 922 is situated opposite passageway 930 in fixed frame 106. This construction allows turning instrument 934 to be inserted through passageway 930 and be attached to attaching fixture 924 without opening the display device.

In some embodiments, turning instrument 934 is operated by hand, in other embodiments by a motor. In some embodiments turning instrument 934 is fixed in place in attaching fixture 924, and in others is detachable. Similarly in some embodiments the motor is substantially permanently fixed to the display device, optionally to frame 106, and in other embodiments the motor is detachable. In some embodiments passageway 930 is protected by a cover.

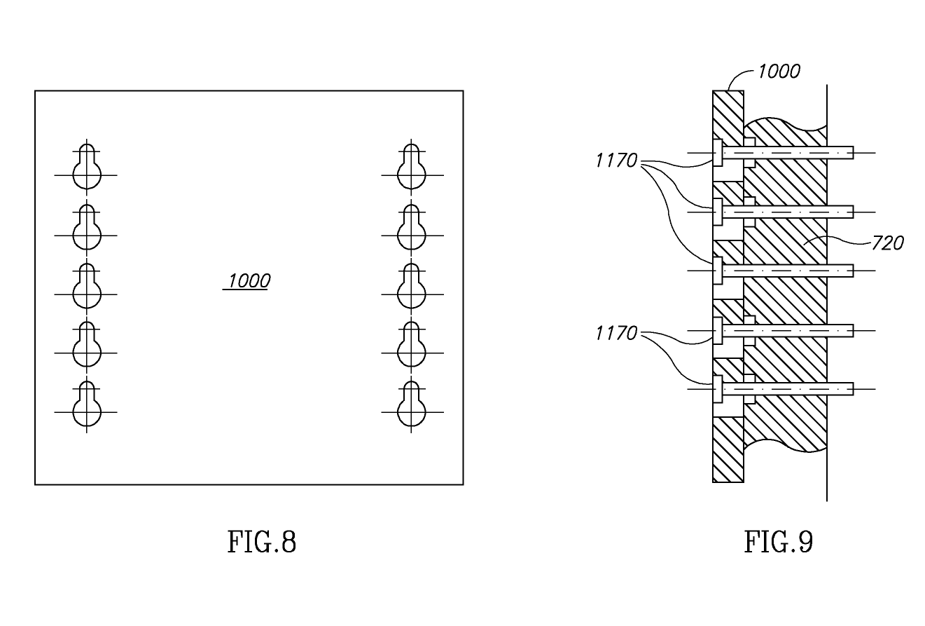

FIG. 8 shows an indicia carrier backing 1000. In some embodiments indicia carrier holder 112 is replaced by indicia carrier backing 1000, upon which indicia carrier 110 is pasted. Pins 1170 for holding indicia carrier backing 1000, shown in FIG. 9, are fixed in bars 710 and 720 of FIG. 7B. When inserting indicia carrier backing 1000 on pins 1170, pins 1170 are extended, and indicia carrier backing 1000 is inserted on pins 1170, then pins 1170 are pushed back into place as shown in FIG. 9. With this method indicia carrier backing 1000 can be quickly and easily changed. Alternatively, other methods of attaching indicia carrier backing 1000 to either or both of bars 710 and 720 may be employed, for example pasting, clamping or using any appropriate fastening method or combination of methods.

In some embodiments indicia carrier backing 1000 is a solid plate made of a plastic material, upon which the indicia carrier is pasted or otherwise fixed. Indicia carrier 110 may then be made flexible so that it can match expansion caused by temperature fluctuations of the backing. This indicia carrier backing 1000 fits in parallel grooves in bars 710 and 720, and is removable.

As described above, quick replacement of indicia carrier 110 is optionally achieved by placing the indicia carrier 110 in an envelope shaped holder 112 (FIG. 1B). Quick replacement of indicia carrier backing 1000 is optionally achieved based on the orientation of pins 1170.

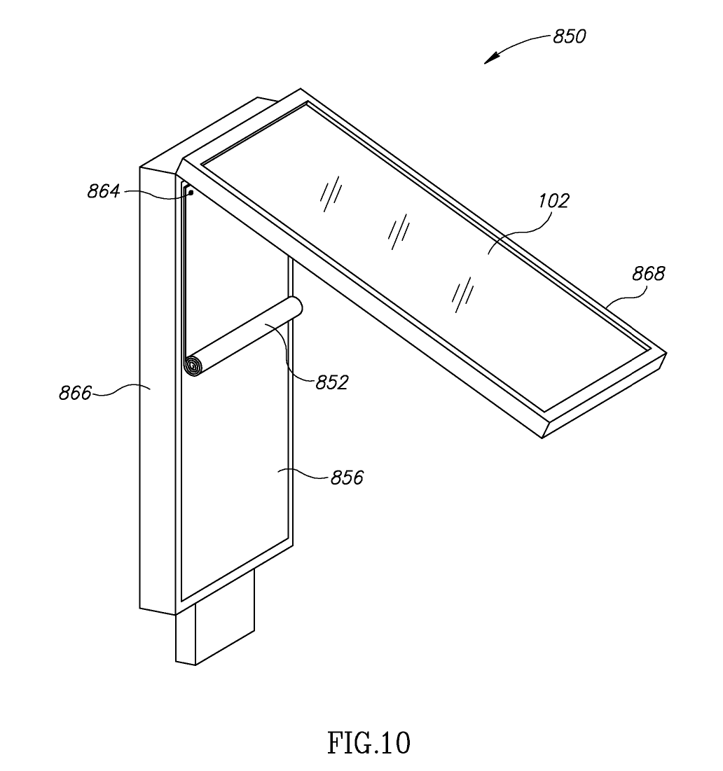

FIG. 10 is a schematic view of a display unit 850, in accordance with an exemplary embodiment of the invention. Display unit 850 comprises a frame 866 having a front door 868. Front door 868 carries a lens array 102. A back board 856 is mounted on a moving bar within frame 866. An indicia carrier 852 is placed on back board 856.

Indicia carrier 852 is optionally coupled to back board 856 detachably, with a minimal amount of interlocking, if at all, in order to allow fast replacement of the indicia carrier. Optionally, friction provides most of the coupling between indicia carrier 852 and back board 856.

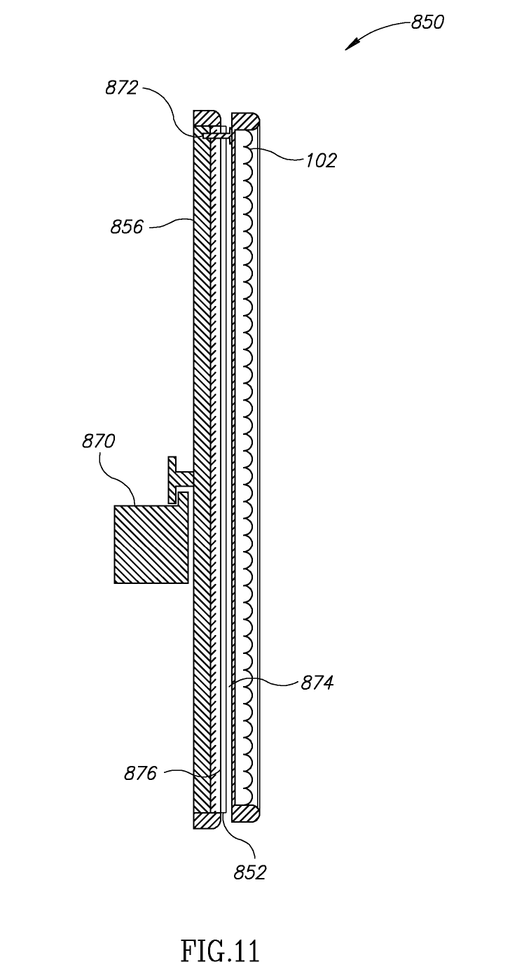

Optionally, indicia carrier 852 has two holes (864 and another hole on the upper right corner), which are attached to respective pins (not shown), hooks or other couplers on board 856. In some embodiments of the invention, board 856 includes respective holes which receive plastic snaps (872 in FIG. 11) that pass through the holes in indicia carrier 852. Plastic snaps 872 optionally have wide heads which do not damage lens array 102. Optionally, the number of snaps 872 used is minimal in order to reduce the time required to replace indicia carrier 852. In an exemplary embodiment of the invention, only one or two snaps are used. Optionally, all the snaps used are on a same side (e.g., the upper side) of indicia carrier 852, for simplicity of replacement.

The indicia carriers 852 are optionally carried rolled up to display units 850, for simplicity of transport. In inserting indicia carrier 852 to display unit 850, a maintenance person optionally lifts front door 868, removes the old indicia carrier, places the two holes 864 in place and attaches the pins. The indicia carrier 852 is then allowed to roll down due to gravity and/or human aid and front door 868 is closed. The replacement process can thus be simple and/or fast and can be performed by a single person.

FIG. 11 is a cross-sectional view of display unit 850, in accordance with an exemplary embodiment of the invention. A moving bar 870 carries back board 856, such that the back board moves with the moving bar. A motor (not shown) actuates horizontal movement of bar 870 (into the page in FIG. 11) for changing the images being displayed. In some embodiments of the invention, an alignment system (not shown) adjusts the orientation of moving bar 870 and hence of back board 856 and indicia carrier 852. In some embodiments of the invention, the alignment system includes a remote control which allows adjusting the orientation of the indicia carrier 852 after front door 868 is closed.

A face 874 of indicia carrier 852 facing lens array 102 optionally has a low friction value upon lens array 102, such that indicia carrier 852 can move substantially freely relative to lens array 102 even when lens array 102 and indicia carrier 852 are touching. An opposite face 876 of indicia carrier 852, facing back board 856, has a relatively high friction value upon back board 856, such that indicia carrier 852 moves with back board 856. The friction level between indicia carrier 852 and back board 856 is optionally at least 5 times, 10 times or even 50 times higher than the friction level between indicia carrier 852 and lens array 102. Optionally, the friction coupling is much stronger than the coupling due to the attachment of snaps (or any other interlocking element), for example by at least a factor of 5 or even 10. Alternatively, indicia carrier 852 is not attached to back board 856 but moves with the back board only due to the friction.

In some embodiments of the invention, the friction prevents distortion of the indicia carrier due to the motion of areas of the indicia carrier 852 that are attached to back board 856 while other areas not attached to back board 856 do not move. The friction (or other non-interlocking coupling) prevents such a distortion, as a large area of indicia carrier 852, for example more than 20%, 50% or even 80% of the indicia carrier is coupled to back board 856.

In some embodiments of the invention, the face area of back board 856 is at least as large as the face area of indicia carrier 852, and entirely overlaps indicia carrier 852, so as to maximize the friction attachment of carrier 852 and back board 856.

Alternatively to moving back board 856, lens array 102 is moved. Due to the low friction of indicia carrier 852 relative to lens array 102, indicia carrier 852 will remain stationary while lens array 102 moves, so that the displayed image changes due to the movement of lens array 102.

The high friction between indicia carrier 852 and back board 856 and/or the low friction between indicia carrier 852 and lens array 102 are achieved, in some embodiments of the invention, by processing (e.g., coating) indicia carrier 852. The coating is also useful in reducing the wear of the images.

In some embodiments of the invention, indicia carrier 852 comprises a thin paper or cardboard which is laminated on the image face 874 with a low friction lamination (e.g., polypropylene, polyester) and on the opposite face 876, with a high friction lamination (e.g., PVC, polycarbonate, silicon) or spray. Alternatively, smooth ink is used printing the images.

In another exemplary embodiment of the invention, indicia carrier 852 comprises a plastic board on which the image is printed. The plastic board is optionally smoothed on the image side facing lens array 102, such that the friction with lens array 102 is low, while the side of the plastic board not printed on is not smoothed and remains rough. The smoothing of the image side is performed both for the low friction with lens array 102 and for the quality of the printing of the images.

Alternatively or additionally to processing indicia carrier 852 in order to achieve desired friction properties, back board 856 and/or lens array 102 are processed in order to achieve the required friction properties. In this alternative, indicia carrier 852 which is produced in large numbers does not necessarily need to be processed for smoothness, such that the cost of manufacturing indicia carrier 852 is not increased in order to achieve the desired friction properties.

In some embodiments of the invention in accordance with this alternative, back board 856 is formed from, or covered by, a spongy foam material, such as an open cell or a closed cell material. Alternatively or additionally, back board 856 comprises a coarse cloth which has a high friction level Further alternatively or additionally, back board 856 comprises a rubber with a high friction level In some embodiments of the invention, back board 856 is coated by a high friction lamination (e.g., PVC, polycarbonate, silicon). Optionally, back board 856 comprises a durable material which does not deform due to movement and/or non-extreme temperatures. Alternatively or additionally, back board 856 comprises a sturdy frame, for example an aluminum frame, which prevents deformation of the back board. In some embodiments of the invention, back board 856 comprises two or more parallel plastic boards which form a substantially hollow sandwich board, such that the board is light weight but durable. Optionally, the back board is formed of one or more polypropylene sheets, such as those available from Polygal Plastic Industries Ltd. in Israel.

In some embodiments of the invention, back board 856 comprises an elastic or springy material which pushes the indicia carrier toward the lens, such that the indicia carrier is held between the lens array and back board and does not bend or otherwise distort.

In order to reduce the friction between indicia carrier 852 and lens array 102, lens array 102 is optionally coated on its side facing indicia carrier 852 with a low friction transparent coating, for example using an ultra violet coating procedure. Alternatively or additionally, a transparent wall with a low friction level is positioned between indicia carrier 852 and lens array 102. In the present description and claims this wall if it exists is considered as part of an image selector including the display optics.

In some embodiments of the invention, the high friction between indicia carrier 852 and back board 856 is achieved by mounting a plurality of rubber suction cups on the back side of indicia carrier 852, facing back board 856. Back board 856 optionally comprises a glass (or other smooth and/or air impervious) material to which the rubber suction cups stick. Thus, indicia carrier 852 is easily placed on board 856 and is easily removed therefrom Other methods of non interlocking coupling which may be used include magnetic coupling and/or a weak glue which is easily removable.

In some embodiments of the invention, back board 852 comprises a solid board. Alternatively to using a solid back board to move with indicia carrier 852, a mesh having a high friction with indicia carrier 852, is used. The mesh generally has a lower weight than a solid board and is therefore easier to manipulate. In some embodiments of the invention, the mesh is held under tension, such that it forms high friction contact with the indicia carrier.

It is noted that the embodiments of the present invention and especially the embodiment of FIGS. 10 and 11, are not limited to any specific size of displays, to any specific motion source and/or to any specific indicia type. Particularly, friction based movement may be used with small displays of for example 20×30 centimeters or even less and for large displays of, for example, 120×180 centimeters or even more and for substantially any displays known in the art.

In some embodiments of the invention, instead of opening front door 868 upward, the front door may be opened on side hinges or may be a sliding door opened by being pushed away from frame 866 parallel to the frame. Alternatively or additionally, instead of moving lens array 102 in order to insert indicia carrier 852 into place, back board 856 is moved. In some embodiments of the invention, frame 868 includes a slot through which indicia carrier 852 is inserted into place, such that the required separation of lens array 102 and back board 856 for insertion of indicia carrier 852 is minimal.

In some embodiments of the present invention, motor 424 is controlled by a control device which controls the motion function of indicia frame 701, which, in the present embodiment, comprises bars 710 and 720 and the indicia carrier 110 in holder 112 or held in an alternative fashion.

In some embodiments a control device controls the action of motor 424. For example in some embodiments, control device 550 as shown in FIG. 3 is connected not only to alignment motor 500 shown on FIG. 3, but also to drive motor 424. Thus in some embodiments control device 550 controls the motion of the indicia continuously. In some embodiments control device 550 comprises computing elements, for example one or more processors and/or one or more memory units, to control each phase of the indicia motion cycle independently. Thus it is possible to give different pictures on the display different times of exposure, and/or to vary the order of the display of the different pictures, for example instead of cycling the pictures in the order of (1, 2, 3, 4, 3, 2, 1) the control device may instruct the motor to perform a cycle such as (1, 2, 3, 2, 3, 4, 3, 4, 3, 2, 1). The control device may instruct drive motor 424 to skip certain pictures altogether.

In some embodiments of the invention, control device 550 has a plurality of preprogrammed motion functions. When a new indicia is inserted to indicia frame 701, a matching preprogrammed motion function is selected for displaying the images of the indicia. In some embodiments of the invention, a maintenance person selects the motion function using a human interface of the control mechanism Alternatively or additionally, the indicia include data and/or programming markings which may be automatically read by an input unit (e.g., a bar code reader) of the control device.

In some embodiments, a control unit such as control unit 570 of FIG. 3 receives the instructions for the action of drive motor 424 from an Input-Output device, which in some embodiments may be a standard keyboard and/or mouse, which connects to control unit 570. Alternatively or additionally the Input-Output device is a hand-held computing device, for example a Palm Pilot type device, which transfers instructions to control unit 570. In some embodiments control unit 570 comprises computing elements, for example one or more processors, memory elements and/or Input-Output elements. The motion cycle is delivered by control unit 570 to control device 550.

In some embodiments of the invention, the motion function controls the distances which indicia frame 710 moves in changing the image displayed by display device 100. These distances are selected responsive to the indicia currently inserted to indicia frame 701. In some embodiments of the invention, the image changing distances are equal for all the images of the indicia. Alternatively, the image changing distance is different for different images. For example, in moving between a first image and a second image, indicia frame 701 moves a first distance while in changing from a second image to a third image indicia frame 701 moves a second distance different from the first distance.

In some embodiments of the invention, the motion function determines the time in which the different images of the indicia are displayed. In some embodiments of the invention, all the images of the indicia are displayed for equal intervals, the length of which intervals is controlled by the control mechanism. For example, indicia which carry picture advertisements without texts have short display periods for the images (in each display round), while indicia with heavy text advertisements have long display periods. Alternatively, different images of the indicia are displayed for different period lengths, for example according to the amount paid for their advertisement.

In some embodiments of the invention, the motion function is set responsive to the image quality of the indicia and/or of lens array 102. For example, low quality images may be displayed for very short periods, preventing viewers from noticing imperfections.

In some embodiments of the invention, the motion function changes responsive to one or more external parameters such as the time of day and/or the date. For example, a first advertisement which is directed to teenagers, receives a larger portion of the display time of a display round during times of the day in which teenagers travel, while advertisements directed to elderly citizens receive larger portions of the display time at times in which elderly citizens travel.

In some embodiments of the invention, the control mechanism comprises one or more sensors (e.g., temperature and/or other weather sensors) and the motion function changes responsive to the indications of the sensors. For example, in cold days longer display periods are given to advertisements for hot drinks while on hot days longer display periods are given to cold drinks. In some embodiments of the invention, the motion function may include not displaying certain images altogether, for example advertisements for cold drinks on cold days. In some embodiments of the invention, indicia are printed with a large number of images and the motion function is used to change the identity of the images being displayed. Thus, the frequency of changing the indicia may be reduced substantially.

In some embodiments of the invention, the control mechanism comprises a communication unit which receives remote instructions. In some embodiments of the invention, an advertisement may be removed or enhanced by sending a remote control instruction to the control mechanism changing the motion function. Alternatively or additionally, when a new indicia is inserted, a maintenance person views the images being displayed. Optionally, if one or more of the images are of low quality the motion function is changed so as not to display the low quality image. In some embodiments of the invention, each image is printed on the indicia twice and the maintenance person selects which of the images should be displayed.

In some embodiments of the invention, lens array 102 comprises relatively large cylindrical lenses, i.e., having a width larger than 11 mm or even 15 mm. The use of such large lenses reduces the printing precision required in printing the indicia inserted to display device 100. It also reduces the sensitivity of the viewed image to small inaccuracies or distortions of the lens array. It is noted that the production of such large lenses is generally considered as requiring a lower precision for a given cost. Therefore, in some embodiments of the invention, lens array 102 is produced in a relatively low precision process. Various methods of compensating for the low precision of the production process are described herein.

In some embodiments of the invention, lens array 102 is manufactured by extrusion or by Computerized Numerical Control. Alternatively, lens array 102 is manufactured using a molding method or roller imprinting.

In an exemplary embodiment of the invention, the display device and the indicia carrier are treated as a complete system with respect to achieving a desired image quality. Thus, the indicia formation process, the alignment and the available device characteristics are considered as variables that can be modified to achieve the desired effect. In one example, strips in the indicia are printed twice, side by side, so that low precision of the lens will still bring a strip from the same image. In another example, the printing on the indicia is matched to known display characteristics. In another example, alignment proceeds only until a required quality is achieved. In another example, certain indicia carriers are used only with higher quality devices (e.g., as determined by testing). In another example, an indicia is formed with distortions that match those of a display device and/or environment. In another example, alignment is used to correct for distortion in a printing process.

In some embodiments of the invention, lens array 102 is produced from a material which has high transparency, and/or achromatism (i.e., having substantially the same index of refraction for all visible light) properties. Alternatively or additionally, the material of lens array 102 has a small heat expansion coefficient and/or color stability (does not discolor with time in sunlight). In an exemplary embodiment of the invention, lens array 102 is produced from an acrylic plastic or polypropylene. Alternatively, as discussed below, lens array 102 comprises a polycarbonate which is durable in higher temperatures.

In some embodiments of the invention, indicia carrier 110 is produced from a material with a heat expansion coefficient substantially equal to that of the material of lens array 102 (or the same material). Thus, changes in heat, for example due to weather effects, distort indicia carrier 110 and lens array 102 substantially equally, minimizing the introduction of distortions due to temperature changes. One common material for this application is polypropylene. Alternatively or additionally, indicia carrier 110 is pasted on a backing having the desired expansion properties. Alternatively or additionally, the backing and/or the lens (or frames thereof, and/or a volume between them) are heated to distort a desired, compensating, amount.

In some embodiments of the invention, lens assembly 102 is firmly fastened to fixed frame 106 on one or more sides, so as to prevent expansion and contraction of lens array 102 due to temperature changes, on those sides. In some embodiments of the invention, lens array 102 is firmly fastened to fixed frame 106 on the two sides parallel to the direction of the axes of the cylindrical lens array 102. Alternatively, three sides of lens array 102 are fastened to fixed frame 106, allowing expansion of lens array 102 in only one direction.

In some embodiments of the invention, indicia carrier 110 comprises a prepared plastic such as PVC. Alternatively, indicia carrier 110 comprises Panaflex and/or Shimshonite (different weaves of plastic materials) which are relatively strong and stable. Alternatively or additionally, indicia carrier 110 comprises a thick paper or cardboard. Further alternatively, the indicia carrier comprises a photographic print paper, which enables high printing resolution. The indicia carrier may be provided, for example, as a single segment or as multiple segments.

In some embodiments of the invention, the indicia is printed directly on indicia carrier 110. Alternatively, the indicia is printed on a thin substrate such as paper and is then glued or mechanically attached onto indicia carrier 110. In some embodiments of the invention, the indicia is printed by a printer-plotter and/or by screen printing. Alternatively or additionally, the indicia is printed using a lithographic process, offset printing and/or any other printing process.

Some embodiments of the present invention support placing indicia carrier 112 at different distances from lens array 102, for example using preset places or by providing a distance adjustment means, such as a screw or a linear translator. In an exemplary embodiment of the invention, a plurality of perpendicular rods are provided for supporting the indicia carrier or its frame and/or the lens array and/or its frame. These rods are slotted at positions that correspond to the pre-set places. This distance affects the effective magnification of lens 102, which, in turn, dictate the width of strip required (or the effective width utilized). Reducing the width allows placing a greater number of pictures on a single indicia. Thus, a single device can be used to display indicia carriers with different numbers of pictures at different times.

It is noted that non-cylindrical arrays may be used as well. In one embodiment, this is applied by providing that at each different spatial positioning of the lens and the indicia carrier, substantially only portions of a single image are viewed by the lens.

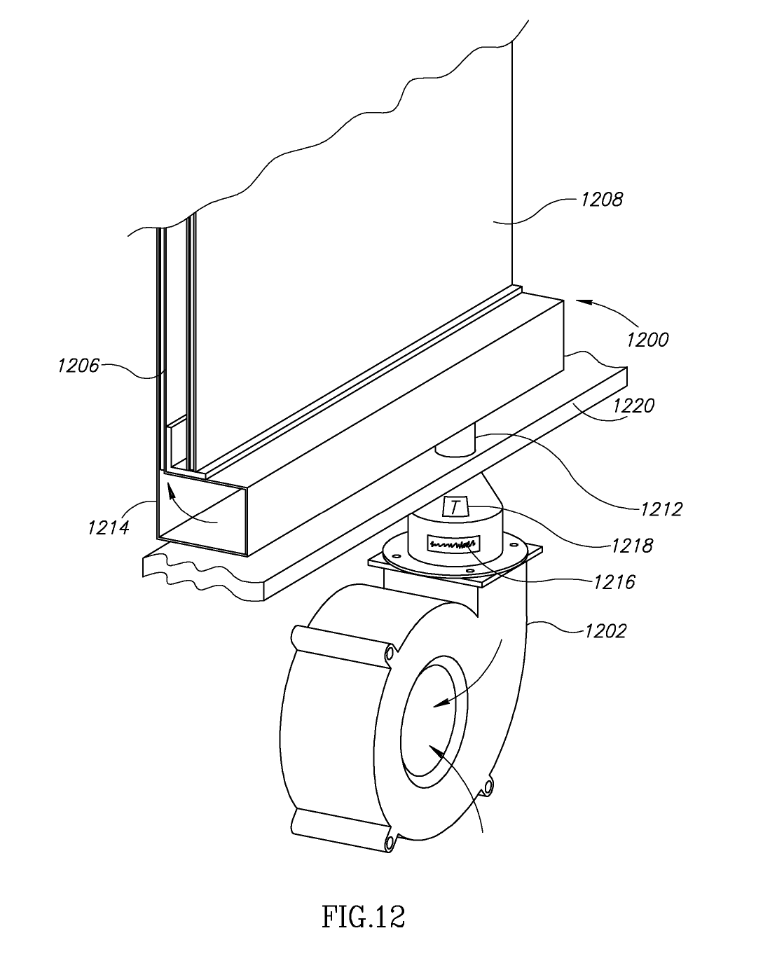

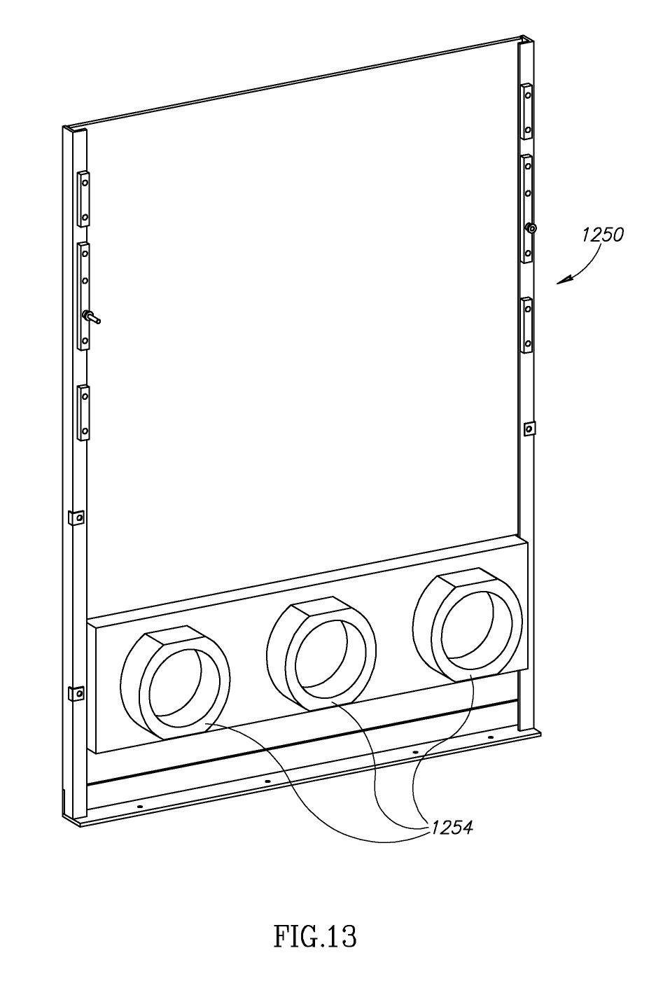

FIG. 12 is a schematic illustration of a lower portion of a back board 1200 of a display device, with a manifold fan 1202, in accordance with an exemplary embodiment of the invention. Back board 1200 optionally comprises a pair of polypropylene sheets 1206 and 1208. An indicia carrier is placed against the surface of sheet 1206 opposite sheet 1208, using any of the methods described above. In some embodiments of the invention, fan 1202 blows air into a tube 1212 which leads the air into a lower shaft 1214 connected to back board 1200 and from there to within sheet 1206, in order to cool the board. The fan optionally pushes in cold air or removes hot air, and/or equalizes the temperature throughout the display device.

In some embodiments of the invention, manifold fan 1202 is fixed to the frame of the display device, represented by a bottom board 1220. Back board 1200 optionally moves in order to change the images displayed by the display device. Optionally, tube 1212 is flexible, in order to allow the movement of back board 1200 relative to bottom board 1220 of the frame. Alternatively or additionally, fan 1202 moves with back board 1200 and is not fixed to the frame. In some embodiments of the invention, for example in accordance with this alternative, manifold fan 1202 comprises flexible tubes.

Optionally, for simplicity, fan 1202 operates continuously, regardless of the temperature within the display device. Alternatively, fan 1202 is connected to a thermostat 1218, which causes fan 1202 to operate when the temperature within the display device is above a predetermined temperature, such as 50° C. In some embodiments of the invention, a heater 1216 is located at the entrance to tube 1212 and heats the air provided from fan 1202 into sheet 1206. Optionally, heater 1216 is operated when the temperature within the display device is below a predetermined value, such that the air blown by fan 1202 heats the display device. Fan 1202 may operate continuously or may be operated only when heater 1216 is operative. In an exemplary embodiment of the invention, thermostat 1218 is used only to control heater 1216 while fan 1202 operates continuously.

As shown, fan 1202 blows air from the bottom of the display device to its roof, as cool air settles and thus the fan provides cooler air. In some embodiments of the invention, the frame of the display device has holes on its top side, which holes allow the blown air to exit the display device. In some embodiments of the invention, in which the display device is a static display device converted into a multi-image display device, the conversion includes perforating holes in the frame. Optionally, the holes have covers which prevent entrance of rain, as is known in the art. For example, the covers may include one-way flap vents or simple covers that force the air to exit in an angle and prevent rain from entering the hole.

Alternatively to locating the fan 1202 at the bottom of the display device, the fan may be located on top of the display device, blowing air down, or may be located on the right or left of the device, as well as in any other location according to where is available space for positioning a fan. In some embodiments of the invention, more than one fan is employed and/or the air flow from one or more of the fans is led through a plurality of tubes to different areas of back board 1200.

FIG. 13 is a schematic illustration of a back board 1250, in accordance with an exemplary embodiment of the invention. Back board 1250 carries one or more fans 1254, such that the fans move with the back board. The air from the fan is optionally blown through internal passageways of back board 1250, in order to cool the back board, in a manner similar to that described with reference to FIG. 12.

Alternatively to using fans, other cooling devices may be used, such as a small air conditioner.

Alternatively or additionally to using a fan or other cooling device, lens array 102 and/or other elements of a display device are formed of materials that a durable and do not distort in a manner which substantially impedes the viewed image up to relatively high temperatures, for example up to at least 100° C. (centigrade), at least 110° C. or even at least 120° C. In an exemplary embodiment of the invention, a material durable up to about 130° C. and having a melting point of at least 200° C., for example about 250° C., is used. Optionally, up to the relatively high temperature, the lens does not become so soft that it distorts under its own weight and/or under external forces (e.g., tension, compression) applied to it. In some embodiments of the invention, up to the relatively high temperature, the lens does not distort in a manner which permanently impedes its optical properties.

In some embodiments of the invention, a lens array 102 comprises a polycarbonate, such as a polyaromatic carbonate or a polyaliphatic carbonate. Possibly, the lens array is formed from the polycarbonate using an injection molded process. An exemplary size for lens array 102 formed of a polycarbonate is 80×100 centimeters, although larger or smaller lens arrays may be used, depending on the desired display size and the production method used.

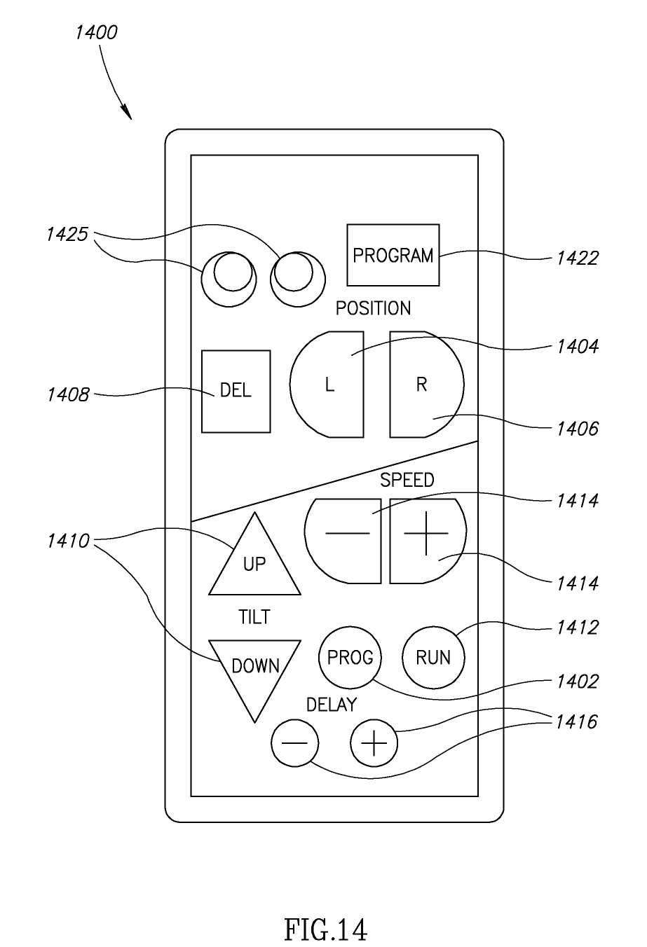

FIG. 14 is a schematic illustration of a remote control unit 1400, in accordance with an exemplary embodiment of the invention. Optionally, after inserting a new indicia carrier 110 (FIG. 1C) into a display device and closing the frame of the display device, the remote control is connected to the display device, through a wire socket or through a wireless protocol. A program button 1402 is optionally used to move the driving mechanism of the indicia carrier (e.g., of the back board), to a home state. A left button 1404 and a right button 1406 are optionally used to manually move the indicia carrier to a position in which one of the images in viewed clearly. The technician performing the installation optionally moves the indicia carrier to both sides to verify that the selected position is the best view of the image. A program select button 1422 is then pressed to indicate the selected position of the first image. A delete button 1408 may be used to cancel in incorrect pressing of program select button 1422. The indicia carrier is then moved to a position in which a second image is best viewed and the program select button 1422 is pressed again. Optionally, this process is repeated until all the images which it is desired to display were selected. In some embodiments of the invention, the order in which the images are selected is the order of their display. Optionally, an image may be selected more than once or may not be selected at all, according to the desired exposure of each of the images by the specific display device.

Tilt buttons 1410 are optionally used for alignment of the indicia carrier with the lens array. A run button 1412 is optionally used to begin the automatic operation of the display. In some embodiments of the invention, the driving mechanism of the display moves periodically (e.g., every 100 or 200 display cycles) back to the home position and then begins display cycles again, in order to synchronize the display.

Speed buttons 1414 are optionally used to adjust the speed of movement between images and delay buttons 1416 are optionally used to adjust the duration of display of each image station (note that the same image may be displayed in several image stations).

One or more LEDs 1425 are used to indicate the operation state of the display device and/or of the remote control It is noted that the remote control may have a more complex display and/or may allow for more complex programming. In addition, the order of acts may be changed.

It is noted that the spatial positioning of lens array 102 relative to the frame in any of the above embodiments may be one dimensional or two dimensional, for example vertical and/or horizontal motion. The motion between pictures need not be in a straight line or be the same for different picture transitions. In addition, some embodiments of the invention may utilize other types of selective viewing mechanisms, even ones that do not use lens, for example, a perforated surface that presents the image that corresponds to the parts visible through the perforations.

In some embodiments of the invention embodiments, the plane in which the indicia carrier moves is not in the focal plane of the lens array, thus preventing the scorching of the indicia by incident sunlight.

It will be appreciated that the above described methods may be varied in many ways, including, changing the order of steps, and the exact implementation used, for example, any combination of one or more of the lens, indicia holder and indicia carrier may be moved to achieve the desired relative motion. It should also be appreciated that the above described description of methods and apparatus are to be interpreted as including apparatus for carrying out the methods and methods of using the apparatus.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments describe the best mode contemplated by the inventors and therefore include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A display device, comprising:
an image selector, for selectively displaying images of a multi-image indicia carrier;
a back board;
a motor that provides relative movement between the back board and the image selector; and
an indicia carrier detachably placed between the image selector and the back board, such that it moves with the back board, at least partially due to a non-interlocking coupling of the indicia carrier to the back board.

2. A display according to claim 1, wherein the non-interlocking coupling includes friction values such that a friction level between the board and the indicia carrier is substantially higher than a friction level between the image selector and the indicia carrier.

3. A display according to claim 1, wherein the indicia carrier moves with the back board mainly due to the non-interlocking coupling.

4. A display according to claim 1, wherein a friction level between the indicia carrier and the board is at least twice the friction level between the indicia carrier and the image selector.

5. A display according to claim 4, wherein a friction level between the indicia carrier and the board is at least ten times the friction level between the indicia carrier and the image selector.

6. A display according to claim 1, wherein the board is moved by the motor and the image selector remains stationary.

7. A display according to claim 1, wherein the image selector is moved by the motor and the board remains stationary.

8. A display according to claim 1, wherein the indicia carrier is not coupled to the board using any interlocking coupling.

9. A display according to claim 1, wherein the indicia carrier is attached to the board by at most four interlocking elements.

10. A display according to claim 1, wherein the indicia carrier is attached to the board using interlocking elements only along one side of the board.

11. A display according to claim 1, wherein the indicia carrier comprises an image sheet laminated in a manner which provides substantially different friction levels on its opposite faces.

12. A display according to claim 11, wherein the image sheet is laminated with different materials on different faces.

13. A display according to claim 11, wherein the image sheet is finished with different methods on different faces.

14. A display according to claim 1, wherein the indicia carrier comprises a plastic base which is smoothed on an image face and is rough on an opposite face.

15. A display according claim 1, wherein the board comprises a foam material at least on its side facing the indicia carrier.

16. A display according to claim 1, wherein the board covers at least 90% of the area of the indicia carrier.

17. A display according to claim 1, wherein the indicia carrier comprises a sheet which can be rolled into a cylinder having a diameter smaller than a fifth of the length of the indicia carrier, before being inserted into the display device.

18. A display according to claim 1, wherein the indicia carrier does not include a rigid frame.

19. A display according to claim 1, wherein the back board pushes the indicia carrier against the image selector.

20. A display according to claim 1, wherein absent the non-interlocking coupling the indicia carrier would not move with the back board or would be distorted.

21. A display according to claim 1, wherein the back board has a mesh structure.

22. A display according to claim 1, wherein the back board is coated with PVC or silicon on a side facing the indicia carrier.

23. A display device, comprising:
an image selector, for selectively displaying images of a multi-image indicia carrier;
an indicia carrier holder;
a motor that provides relative movement between the indicia carrier holder and the image selector; and
a fan adapted to blow air in the vicinity of an indicia carrier held by the indicia carrier holder.

24. A display according to claim 23, comprising a heater adapted to heat air blown by the fan.

25. A display according to claim 23, comprising a thermostat adapted to operate the fan at predetermined temperature levels.

26. A display according to claim 25, wherein the fan is positioned to blow air upwards along at least 20% of the height of the indicia carrier.

27. A display device, comprising:
an image selector, for selectively displaying images of a multi-image indicia carrier;
an indicia carrier holder;
a motor that provides relative movement between the indicia carrier holder and the image selector;
a cooling mechanism adapted to cool an indicia carrier held by the indicia carrier holder; and
a power source adapted to power the cooling mechanism.

28. A display according to claim 27, wherein the cooling mechanism comprises a fan.

29. A display device, comprising:
an image selector, for selectively displaying images of a multi-image indicia carrier;
an indicia carrier holder; and
a motor that provides relative movement between the indicia carrier holder and the image selector,
wherein the image selector is formed from a material which does not distort in a manner which substantially impedes its optical properties at temperatures below 100° C.

30. A display device according to claim 29, wherein the image selector is formed from a polycarbonate.

31. A display device according to claim 29, wherein the image selector is formed from a material which does not distort at temperatures below 120° C.

32. A display device according to claim 29, wherein the image selector has an area of at least 0.5 square meters.
